(19) United States
(12) Patent Application Publication
(10) Pub. No.: US 2026/0366647 A1
(43) Pub. Date: Nov. 19, 2026

(54) SUBSEA CABLE STABILIZATION

(71) Applicants: Mrunal Vinay Bhalerao, Ann Arbor, MI (US); Alexander Vakakis, Ann Arbor, MI (US); Anargyros Michaloliakos, Ann Arbor, MI (US); Matthew Hall, Ann Arbor, MI (US); Ryan Davies, Ann Arbor, MI (US); Malakonda Reddy Lekkala, Ann Arbor, MI (US); The Regents of the University of Michigan, Ann Arbor, MI (US)

(72) Inventors: Lei Zuo, Ann Arbor, MI (US); Wei Ying Wong, Ann Arbor, MI (US); Mrunal Vinay Bhalerao, Milpitas, CA (US); Alexander Vakakis, Champaign, IL (US); Anargyros Michaloliakos, San Francisco, CA (US); Matthew Hall, Trondheim (NO); Ryan Davies, Oakland, CA (US); Malakonda Reddy Lekkala, Amherst, MA (US)

(21) Appl. No.: 19/677,866

(22) Filed: May 14, 2026

Related U.S. Application Data
(60) Provisional application No. 63/807,155, filed on May 16, 2025.

(51) Int. Cl. F16L 1/12

(52) U.S. Cl. CPC F16L 1/123

(57) ABSTRACT

A nonlinear energy sink for a subsea cable includes a pair of end masses, at least one post-buckled bar extending between the pair of end masses, and a compressive load assembly extending between the pair of end masses. The compressive load assembly may be configured to apply a compressive force to the at least one post-buckled bar.

### STATEMENT REGARDING FEDERALLY SPONSORED RESEARCH OR DEVELOPMENT

This invention was made with government support under DE-EE0008390 awarded by the U.S. Department of Energy. The government has certain rights in the invention.

This invention was made with the support of the New York State Energy Research and Development Authority (NYSERDA) under agreement No. 132/192898, and NYSERDA may have rights in this invention.

This application claims the benefit of U.S. provisional patent application entitled “SUBSEA POWER CABLE STABILIZATION,” filed on May 16, 2025, and assigned Ser. No. 63/807,155, the entire disclosure of provisional application is hereby expressly incorporated by reference.

### BACKGROUND OF THE DISCLOSURE

### Field of the Disclosure

The disclosure relates generally to devices, methods, and systems for stabilization of subsea cables.

### Brief Description of Related Technology

The rapid deployment of offshore wind energy globally is fueled by advancements in technology, the evolution of supply chains, competitive markets, and extensive experience from large-scale projects. Notably, the U.S. government aims to escalate U.S. offshore wind capacity from under 1 GW to 30 GW by 2030, highlighting the strategic expansion of the offshore wind energy sectors. Floating offshore wind turbines are critical in effectively utilizing vast oceanic areas with rich wind resources, especially in regions where water depths exceed 60 m, rendering traditional fixed-bottom installations cost-prohibitive.

About 20% of an offshore wind farm's expenditure is tied to its electrical infrastructure, which includes costly subsea power cables essential for energy transmission from turbines to shore. However, these subsea cables, especially the dynamic cables that connect floating wind turbine platforms to the substation, face substantial risks of mechanical failures.

A large percentage of all offshore wind related financial losses stem from power cable issues. The dynamic cables are particularly vulnerable, as they are subject to continuous platform motion and environmental forces like tidal currents and waves, which induce oscillations leading to fatigue. Consequently, failures in these cables not only necessitate costly repairs but also significantly undermine the reliability and economic viability of offshore wind farms. Therefore, addressing the stability and durability of dynamic cables is crucial for enhancing the resilience and efficiency of floating offshore wind energy transmission systems.

### SUMMARY OF THE DISCLOSURE

In accordance with one aspect of the present disclosure, a nonlinear energy sink for a subsea cable includes a pair of end masses, at least one post-buckled bar extending between the pair of end masses, and a compressive load assembly extending between the pair of end masses. The compressive load assembly may be configured to apply a compressive force to the at least one post-buckled bar.

In accordance with another aspect of the present disclosure, a vibration mitigation device for a subsea cable includes a pair of end masses, a bar extending between the pair of end masses, and a compressive load assembly. The compressive load assembly may be configured to apply a compressive force to the bar, buckling the bar, such that the bar exhibits a non-linear stiffness.

In accordance with yet another aspect of the present disclosure, a subsea cable system includes a subsea cable and at least one nonlinear energy sink coupled to the subsea cable. The at least one nonlinear energy sink includes a pair of end masses, a post-buckled bar extending between the pair of end masses, a compressive load assembly configured to apply a compressive force to bar; and a clamp coupling the at least one nonlinear energy sink to the subsea cable. The at least one nonlinear energy sink may be configured to reduce an intensity of vortex induced vibration of the subsea cable.

In connection with any of the aforementioned aspects, the devices, methods, and systems described herein may alternatively or additionally include any combination of one or more of the following features. The compressive load assembly may include a segmented shaft including a pair of threaded bolts, each of the pair of threaded bolts extending from a respective one of the pair of end masses, and a threaded coupling coupled to the pair of threaded bolts. Rotation of the threaded coupling may be configured to change a length of the segmented shaft and a magnitude of the compressive force induced in the at least one post-buckled bar. Rotation of the threaded coupling in a first direction may be configured to increase the length of the segmented shaft and reduce the magnitude of the compressive force induced in the at least one post-buckled bar. Rotation of the threaded coupling in a second direction may be configured to decrease the length of the segmented shaft and increase the magnitude of the compressive force induced in the at least one post-buckled bar. The at least one post-buckled bar may comprise two or more post-buckled bars extending between the pair of end masses. The nonlinear energy sink may further include a clamp configured to couple the pair of end masses, the at least one post-buckled bar, and the compressive load assembly to the subsea cable. The clamp may include a pair of arcuate segments hingedly coupled to one another. The pair of arcuate segments may be configured to be closed around the subsea cable, interlocking with one another and securing the subsea cable within the clamp. The clamp may be configured to couple the at least one post-buckled bar to the subsea cable, such that the at least one post-buckled bar is perpendicular to the subsea cable. The nonlinear energy sink may have two or more stable equilibrium positions. The compressive load assembly may include a segmented shaft including a pair of threaded bolts, each of the pair of threaded bolts extending from a respective one of the pair of end masses, and a threaded coupling coupled to the pair of threaded bolts. Rotation of the threaded coupling may be configured to change a length of the segmented shaft and a magnitude of the compressive force induced in the bar. The vibration mitigation device may further include a clamp configured to couple the pair of end masses, the bar, and the compressive load assembly to the subsea cable. The clamp may include a brace configured to receive a portion of the subsea cable and a rod extending between the brace and the bar. The at least one nonlinear energy sink may be coupled to a portion of the subsea cable configured to extend between a floating body and a sea floor. The at least one nonlinear energy sink may comprise two nonlinear energy sinks. The two nonlinear energy sinks may be coupled to the subsea cable in different orientations. The two nonlinear energy sinks may be offset in a range of 60 to 120 degrees from one another. The compressive load assembly may include a segmented shaft including a pair of threaded bolts, each of the pair of threaded bolts extending from a respective one of the pair of end masses, and a threaded coupled coupling the pair of threaded bolts. Rotation of the threaded coupling may be configured to change a length of the segmented shaft and a magnitude of the compressive force induced in the post-buckled bar. The post-buckled bar may have an elongated rectangular cross sectional shape.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates an offshore energy generation system in accordance with one example of the present disclosure.

FIG. 2 illustrates a nonlinear energy sink coupled to a subsea cable in accordance with one example of the present disclosure.

FIG. 3 illustrates a nonlinear energy sink for a subsea cable in accordance with one example of the present disclosure.

FIG. 4 is a graph illustrating the stiffness of a post-buckled bar in accordance with one example of the present disclosure.

FIG. 5 illustrates a plurality of nonlinear energy sinks coupled to a subsea cable in accordance with one example of the present disclosure.

FIG. 6 illustrates a nonlinear energy sink in accordance with another example of the present disclosure.

FIG. 7 illustrates a flowchart for coupling a nonlinear energy sink to a subsea cable in accordance with one example of the present disclosure.

FIG. 8 is a schematic of a lumped mass model computer model for a subsea cable in accordance with one example of the present disclosure.

FIG. 9 is a schematic representation of the relative displacement of a bi-stable non-linear energy sink mass with respect to a subsea cable.

FIG. 10 is a graph illustrating tunability of non-linear stiffness of a bi-stable nonlinear energy sink.

FIG. 11 illustrates four bi-stable non-linear energy sinks attached to a vertical subsea cable in accordance with one example of the present disclosure.

FIG. 12 illustrates force versus displacement curves for multiple numerical model simulations.

FIG. 13 is a graph illustrating setting time in accordance with one example of the present disclosure.

FIG. 14 is table including bi-stable nonlinear energy sink parameters in accordance with one example of the present disclosure.

FIG. 15 depicts the variation in three performance measures in terms of the variations in the three axial stiffnesses for a plurality of simulation runs.

FIG. 16 is a multi-dimensional representation of performance metrics for a plurality of simulation runs.

FIG. 17 illustrates at a node of a subsea cable for cases with and without optimized bi-stable nonlinear energy sinks attached.

FIG. 18 illustrates transient displacements at different locations along a subsea cable with optimized attached bi-stable nonlinear energy sinks and without bi-stable nonlinear energy sinks attached.

FIG. 19 illustrates contour plots of the wavelet transformation of cable responses for cases without and with bi-stable nonlinear energy sinks.

FIG. 20 illustrates relative displacement of optimized bi-stable nonlinear energy sinks with respect to their point of attachment to a subsea cable.

FIG. 21 illustrates contour plots of the magnitudes of the wavelet transform of the relative displacements of several optimized bi-stable nonlinear energy sinks.

FIG. 22 is a table including parameters for a set of four non-linear energy sinks.

FIG. 23 illustrates transient displacement at a node of a subsea cable for subsea cables with bi-stable nonlinear energy sinks, nonlinear energy sinks, and without nonlinear energy sinks.

FIG. 24 illustrates Fast Fourier Transformation (FFT) plots of the transient displacement at a node 5 of a subsea cable for different combinations of cable diameter (D) and cable mass density (M).

FIG. 25 illustrates transient displacement at a node of a subsea cable for cases with and without optimized bi-stable nonlinear energy sinks attached; different combinations of cable diameter (D) and cable mass density (M) are considered.

While the disclosed nonlinear energy sinks for subsea cables, methods, and systems are susceptible of embodiments in various forms, there are illustrated in the drawings (and will hereafter be described) specific embodiments of the invention, with the understanding that the disclosure is intended to be illustrative and is not intended to limit the invention to the specific embodiments described and illustrated herein.

### DETAILED DESCRIPTION OF THE DISCLOSURE

Nonlinear energy sinks for subsea cables are described. The nonlinear energy sinks described herein may be passive bi-stable nonlinear energy sinks. The nonlinear energy sinks described herein may suppress vibration energy in a broadband way, and can be regarded as extensions of linear tuned mass dampers (TMDs) which are narrowband devices. The non-linear energy sinks described herein not only to rapidly absorb and locally dissipate vibration energy, but may also nonlinearly scatter vibration energy from low to high frequencies within the cable itself. Nonlinear scattering vibration energy from low to high frequencies is especially beneficial for vibration mitigation of undersea cables, as at higher frequencies the cable vibrations exhibit drastically reduced amplitudes and are more effectively dissipated by inherent structural damping and hydrodynamic radiation damping. This contrasts with other tuned mass dampers which can only mitigate vibration at a single frequency. The nonlinear energy sinks described herein are effective under varying environmental conditions and their capacity for broadband vibration mitigation make them a retrofit solution for improving the performance and operational safety of dynamic power cables in offshore wind farms and other marine applications.

Provided herein are nonlinear (e.g., bi-stable nonlinear) energy sinks for robustly suppressing vibrations of subsea cables, and thus, increase resiliency of subsea power transmission. Non-linear energy sinks according to the present disclosure may be provided as a retrofit solution for suppressing vibration of existing (e.g., in use) subsea cables. For example, a nonlinear energy sink according to the present disclosure may be retrofitted onto existing subsea power cables, for example, by a diver or remotely operated vehicle) without lifting or removing the cable from the sea. This easy in-situ installation and its capacity for retrofit renders a nonlinear energy sink according to the present disclosure an economical solution to cable oscillation in existing offshore energy generation systems. Nonlinear energy sinks according to the present disclosure may be capable of absorbing and dissipating vibration energy across various ocean conditions. In contrast to other mass dampers, a nonlinear energy sink is a broadband passive device capable of absorbing and dissipating energy adaptatively over a large frequency range. Moreover, a nonlinear energy sink according to the present disclosure can be scaled to variable size and installed on existing subsea cables making them a convenient and economical retrofit solution.

In accordance with some examples, one or more nonlinear energy sinks according to the present disclosure may be coupled to the dynamic portion of a subsea cable extending between a floating energy generator (e.g., floating wind turbine, floating wave energy converter, floating solar module, or the like) and the sea floor. For example, the subsea cable may be a power cable configured to convey power away from the floating energy generator, for example, to a power substation. According to other examples, a nonlinear energy sink according to the present disclosure may be coupled to (e.g., the dynamic portion of) another type of subsea cable. For example, a nonlinear energy sink according to the present disclosure may be coupled to any of the following types of subsea cables: (1) a power cable configured to convey electric current; (2) a mooring line for securing a floating structure to a fixed point on the sea floor; (3) a riser extending between a floating platform and the sea floor; or (4) a subsea pipe or conduit, for example, one configured to convey oil or natural gas. The dynamic portion of subsea cables are susceptible to platform motion and dynamic environmental forces such as ocean currents and tidal flows, which impose complex loading conditions on these structures. Such conditions can potentially lead to severe structural damage or failure of subsea cables if not adequately mitigated.

Alternative methods and devices used to mitigate the effects of environmental loads on subsea cylindrical structures, such as risers and cables, do not mitigate vibration of subsea cables, for example, vortex-induced vibrations, to a satisfactory extent. Examples of these devices include helical strakes, streamlined fairings, and ribbons, hairs, or fringes. These devices are mounted externally on the subsea cable to change the hydrodynamics and reduce vibrations. However, none of these devices are capable of reducing vortex-induced vibrations to a satisfactory extent.

Alternative methods and devices for suppressing vibrations of subsea power cables have drawbacks. The addition of devices on the cable may significantly increase drag which may lead to tremendous energy demands when the cable is being towed. Additionally, when the cable is not being towed, the increased drag may deform a designed or desirable s-shape lay of the cable or cause critical structural loading in regions with large ocean currents. Devices added to the cable as sleeves (e.g., along a substantial or large length of the cable) may be hard to remove and thus repair or replace without removing the cable from the water. Further, sleeve based devices need to be made specifically for the dimensions of a cable to which they are attached, making retrofitting more difficult and increasing costs.

Instead of the use of hydrodynamics-based devices, another approach to reduce the mechanical vibrations is to take advantage of the mechanism of the resonance of mechanical vibrations. For example, a supplementary damping device, or vibration absorber may be used to effectively manage the vibrational energy of primary structures-often referred to as host structures. The principal mechanism behind these vibration absorbers is dynamic vibration absorption, wherein the absorber vibrates out of phase with the structure, creating a counteracting force that reduces the overall oscillation amplitude. The most common form of these devices is the tuned mass damper (TMD), which functions by attaching a mass to the host structure through a linear coupling, precisely tuned to resonate at a critical natural frequency of the host. Although effective within narrow frequency ranges, TMDs operate optimally when the system's natural frequencies are stable.

However, operational conditions of subsea cables vary frequently, for example, with variation in currents, leading to frequency shifts that expose the limitations of a TMD's narrow operational bandwidth; hence, the suppression performance of these devices is not robust to changing frequency or mistuning. Corrosion, variations in temperature and pressure depending on depth, and the tension of the cable are crucial parameters that create a dynamic environment and contribute to the varying operational conditions of the dynamic subsea power cable. Additionally, large displacements experienced by TMDs may lead to excessive stresses and fatigue, potentially compromising structural integrity and system performance. These challenges underscore the necessity for a new class of vibration absorbers that can be effective over a broader frequency spectrum, leading to robust suppression of non-stationary excitations, and at the same time, exhibiting relatively small oscillation amplitudes during operation.

Another inevitable challenge in the subsea environment is the biofouling effect on subsea structures. Biofouling may increase the surface roughness, weight, and size of subsea dynamic cables, thereby altering their dynamic behavior. This change is characterized by modified drag and inertia properties, which can compromise the effectiveness of traditional hydrodynamic devices designed to operate under specific environmental conditions. Additionally, the increased mass attributable to biofouling can alter the natural frequency of subsea cables. This shift is particularly problematic for TMDs, as their effectiveness relies on matching the natural frequency of the structures they are designed to protect. When this frequency deviates from the TMD's optimal range, the efficacy of the damping mechanism diminishes, increasing the risk of structural failure.

In response to these limitations, and to specifically address the challenges associated with subsea dynamic power cables in marine environments, provided herein are nonlinear energy sinks (e.g., nonlinear energy sink devices), which are passive, lightweight, dissipative local attachments with inherent strong nonlinearity configured to be attached to and dissipate vibrational energy from subsea cables. The nonlinear energy sinks according to the present disclosure may leverage their nonlinearity, enabling them to adapt dynamically to and thus dissipate vibrational energy from a subsea cable at varying energy levels.

Unlike conventional TMDs, however, the nonlinear energy sinks described herein may be devoid of a fixed resonance frequency; instead, their response frequencies are tunable with energy, i.e., they adapt to (change with respect to) the frequency and energy content of the applied excitations. This key feature allows the nonlinear energy sinks described herein to dissipate energy from multiple modes of the host structure across a spectrum of energies and frequencies, which results in multi-scale targeted energy transfer. This characteristic makes the nonlinear energy sinks described herein particularly suited for mitigating both stationary and non-stationary vibrations across extensive frequency spectra, thereby adapting to dynamic inputs without the necessity for frequency-specific tuning.

In accordance with some examples of the present disclosure, a vibration mitigation device or nonlinear energy sink for a subsea cable may be bi-stable. A bi-stable vibration mitigation device or nonlinear energy sink according to the present disclosure may be uniquely suited for dissipating energy over a wide frequency range, making them particularly effective in managing vibrations within complex and variable environments like those encountered by subsea dynamic power cables. The extra adaptivity of the dynamics of a bis-stable vibration mitigation device or bi-stable nonlinear energy sink is enabled by its bi-stable nature, which allows it to switch between two stable equilibrium points, facilitating a range of resonant interactions that enhance energy dissipation. Indeed, at high energy levels, a bistable non-linear energy sink according to the present disclosure may engage in strongly modulated oscillations governed by fundamental and superharmonic resonances, effectively dissipating energy through robust oscillatory motion. For lower energy inputs, the bi-stable nonlinear energy sink may undergo chaotic oscillations cross potential wells, as well as subharmonic resonances, which enable efficient energy transfer even under mild excitation. This versatility makes a bi-stable nonlinear energy according the present disclosure a powerful tool for mitigating impulsive or broadband excitations, providing a robust solution to extend the lifespan and improve the stability of subsea dynamic power cables subjected to time-variable marine conditions.

The vibration mitigation devices or nonlinear energy sinks provided herein may be purely passive devices (i.e., no need for any sort of active control), composed of two masses and a post-buckled bar. A vibration mitigation devices or nonlinear energy sinks provided herein, due to its nonlinear design, can effectively absorb energy over a broad frequency range, so it is a broadband vortex-induced vibration (VIV) mitigator, in contrast to a TMD which is a narrowband device. This means that a nonlinear energy sink according to the present disclosure can effectively mitigate both stationary and non-stationary loads (in contrast to a TMD which is effective only close to a single frequency input), which are typical in underwater environments. Perhaps even more important, the nonlinearity of a nonlinear energy sink according to the present disclosure renders it passively adaptive to the applied environmental loads, meaning that its operation is passively tuned depending on the frequency and energy contents of the excitation, and so, if designed appropriately, its operation is robust even in presence of time-varying loads, even with biofouling growth.

A nonlinear energy sink according to the present disclosure is an appropriately designed nonlinear oscillator with strong stiffness nonlinearity and no (or small) linear stiffness component. Although a nonlinear energy sink according to the present disclosure may look similar to tuned TMD in configuration (both are passive devices composed of a mass, a spring, and a damper), they are totally different in nature: The TMD operates effectively only in a narrow frequency band, so it will not work for VIV mitigation of the subsea cable whose excitation frequency vary with the water flow speed. On the other hand, a non-linear energy sink according to the present disclosure possesses strong nonlinearity, it can engage in adaptive resonance capture with different cable modes, thus mitigating the cable vibration over broad frequency ranges. In addition, a nonlinear energy sink according to the present disclosure is especially suitable for accounting transient (time varying) loads, which are typical in undersea cables. Thus, A nonlinear energy sink according to the present disclosure is more robust than the TMD.

According to the present disclosure, a nonlinear energy sink for a subsea (e.g., power) cable may include a pair of end masses, a post-buckled bar extending between the pair of end masses, and a compressive load assembly. A nonlinear energy sink according to the present disclosure may be coupled to and receive energy (e.g., vibration energy, kinetic energy) from a subsea cable. Energy received from the subsea cable may be dissipated by the nonlinear energy sink, mitigating vibration of the subsea cable, for example, mitigating vortex-induced vibration of the cable. A nonlinear energy sink according to the present disclosure may include a clamp configured to couple the pair of end masses, post-buckled bar, and compressive load assembly to the subsea cable. Energy (e.g., vibration energy, kinetic energy) may be transferred from the subsea cable to the nonlinear energy sink via the clamp and may be dissipated locally by the nonlinear energy sink without flowing or being reflected (e.g., returned) back to the subsea cable.

The compressive load assembly may apply a compressive force to the bar, such that the bar under goes buckling, and thus is in a post-buckled state. The post-buckled bar may have a nonlinear stiffness or force-displacement relationship. The nonlinear stiffness of the post-buckled bar may cause the post-buckled bar and the pair of end masses to operate as a mass-spring system having a non-linear stiffness. Due to its nonlinear design, an energy sink according to the present disclosure may effectively absorb energy (e.g., vibration or kinetic energy) from a subsea cable over a broad frequency range.

The ability to absorb energy over a broad frequency range allows the nonlinear energy sink to act as a broadband or broad spectrum vortex-induced vibration mitigator. Further, the ability to absorb energy over a broad frequency range allows the nonlinear energy sink to effectively mitigate both stationary and nonstationary loads to passively adapt to applied environmental loads. Accordingly, the nonlinear energy sink may be passively tuned depending or based on the frequency and/or energy contents absorbed by the nonlinear energy sink.

According to some examples, the compressive load assembly may include a segmented shaft including a pair of threaded bolts and a threaded coupling coupled to the pair of threaded bolts. Each of the threaded bolts may extend from one of the pair of end masses and the threaded coupling may be threadedly coupled to each of the threaded bolts. In accordance with some examples, of the present disclosure, while a nonlinear energy sink according to the present disclosure is capable of absorbing and dissipating energy or vibration over a broad band or broad spectrum, buckling of the post-buckled bar, and thus nonlinear properties of the nonlinear energy sink may be changed by rotating the threaded coupling to increase or decrease the length of the segmented shaft. For example, buckling of the post-buckled shaft may be adjusted so as to modify or tailor the broad band or broad spectrum vibration mitigation properties of the nonlinear energy sink to a particular marine environment.

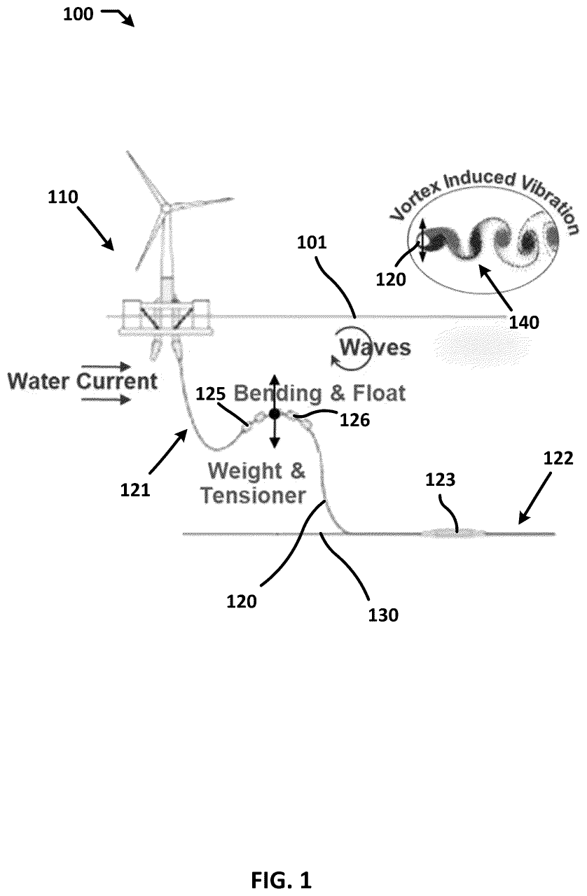

FIG. 1 illustrates an offshore energy generation system 100 in accordance with one example of the present disclosure. The offshore energy distribution system 100 includes a floating wind turbine 110 and a subsea power cable 120. The subsea power cable 120 may be configured to convey or transport power generated by the floating wind turbine 110. As shown in FIG. 1, the subsea power cable includes a dynamic portion 121 extending below the water level 101 between a floating body, for example, the wind turbine 110 and the sea floor 130 and a static portion 122 disposed along the sea floor 130. In accordance with other examples, a dynamic portion 121 of the subsea cable 120 may extend from another floating body, for example, another floating energy generator, such as a floating wave energy converter (WEC), or floating solar module, and the sea floor 130. As shown in FIG. 1, the dynamic portion 121 of the subsea cable may have an s-shaped profile to allow a wide range of motion while avoiding straining the cable. According to some examples, the subsea power cable 120 may further include one or more transition joints 123 connecting segments of the subsea power cable 120, for example, connecting a respective dynamic portion 121 and static portion 122 of the subsea power cable 120.

Further, in some examples, the offshore energy generation system 100 may include one or more weight(s) 125 and one or more buoyancy modules or floats 126 coupled to (e.g., the dynamic portion 121 of) the subsea power cable 120. According to the present disclosure, the one or more weights 125 and one more floats 126 may be disposed along a dynamic portion 121 of the subsea power cable 120, inducing a wave or an (e.g., sideways) “S” shape lay or orientation in the dynamic portion 121 of the subsea power cable 120. The waver or general generally “S” shaped orientation of the dynamic portion 121 of the subsea power cable 120 may allow for a wide range of movement of the floating energy generator (e.g., floating wind turbine 110) and/or the subsea power cable 120 while minimizing strain on the subsea power cable 120. Additionally, or alternatively, the one or more weights 125 and the one or more floats 126 may be used to control laying or installation of the subsea power cable 120 as it is provided from a vessel into a body of water.

The dynamic portion 121 of a subsea power cable 120 extending between a floating energy generator (e.g., a floating wind turbine 110, floating wave energy converter) may be at an increased risk of failure because the dynamic portion is fully exposed to fluid-induced forces from (e.g., floating wind turbine) platform motions, tidal currents and waves causing the cables to oscillate, leading to fatigue and abrasion. Reducing cable vibrations is critical to mitigating cable failure risks and increasing the resiliency of offshore energy transmission.

The subsea power cable 120 may have a circular cross-section. As shown in FIG. 1, fluid flow across the subsea power cable may give rise to vortices 140, which produce cyclic forces that cause cable oscillation. The non-dimensional vortex shedding frequency is given by Strouhal number, which may be determined using equation 1:

$$St = \frac{f \times d}{v} \qquad Eq . 1$$

where f is the frequency of vortex shedding, d is cable diameter, and v is the velocity of fluid flow. The Strouhal number for a cylinder is around 0.2 in Reynolds number in the range of 200-200,000. Therefore, the frequency of vortex shedding on the offshore wind cables varies over a broad range, in typical ocean having water speed varying, for example, from −2 to 2 m/s. For example, the frequency of vortex shedding on offshore cables may vary in proportion to the water flow velocity between 0 and 3 Hz. This vortex induced vibration (VIV) causes time-varying cyclic loading that can lead to fatigue failure and cable motion on the seabed that can lead to failure from abrasion. Reducing cable vibrations is critical to mitigating cable failure risks, increasing the resiliency of offshore wind transmission, and reducing both capital and operations and management cost.

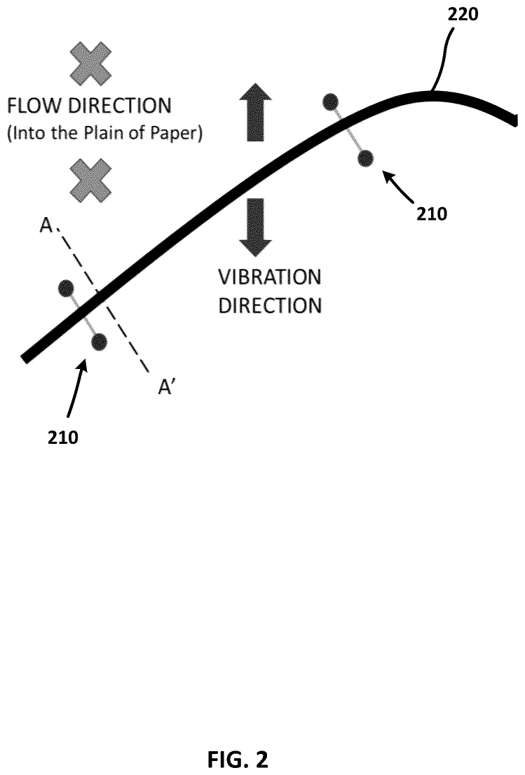

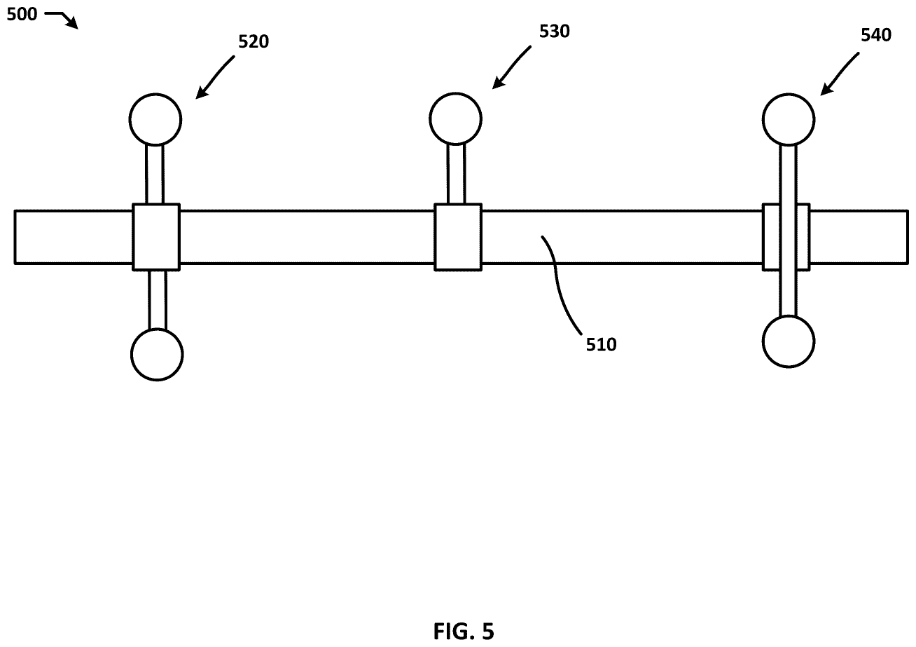

FIG. 2 illustrates a plurality of nonlinear energy sinks 210 coupled to a subsea cable 220 in accordance with one example of the present disclosure. According to the present disclosure, one or more nonlinear energy sinks 210 may be coupled to the subsea cable 220 to mitigate or attenuate vibration of the subsea cable 220. For example, the one or more non-linear energy sinks 210 may be configured to absorb and dissipate vortex-induced vibrational energy from the subsea cable 220. In accordance with some examples, a (e.g., primary) axis along which the subsea cable vibrates may be perpendicular to the direction of a flow of water (e.g., current) past the subsea cable. As described hereinafter in greater detail with respect to FIG. 5, a subsea power cable system according to the present disclosure may include a plurality of non-linear energy sinks disposed in different orientations.

According to the present disclosure, the subsea cable 220 may be any of a power cable, a mooring line, a riser, or a pipe or conduit, or the like. Therefore, in accordance with the present disclosure, unless explicitly identified otherwise, the term “subsea cable” may refer to any of the following: (1) a subsea power cable configured to convey electric current; (2) a subsea mooring line for securing a floating structure to a fixed point on the sea floor; (3) a subsea riser extending between a floating platform and the sea floor; or (4) a subsea pipe or conduit, for example, a pipe or conduit configured to convey oil or natural gas.

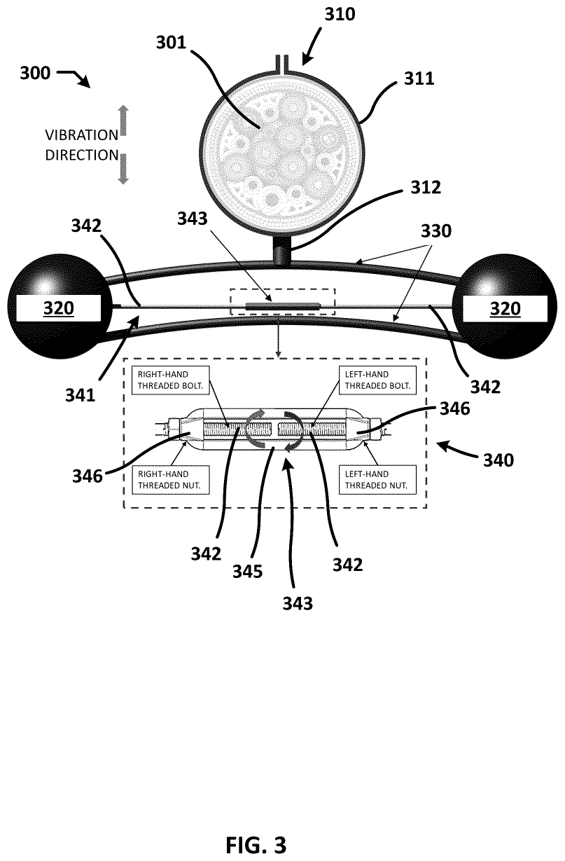

FIG. 3 illustrates an energy sink 300 for subsea cables 301 in accordance with one example of the present disclosure. According to the present disclosure, the subsea cable 301 may be the same as or substantially similar to the subsea cable 120 illustrated and described above with respect to FIG. 1 and/or the subsea cable 220 illustrated and described above with respect to FIG. 2. According to the present disclosure, the energy sink 300 may be a nonlinear energy sink. As described above, the energy sink 300 may be coupled to a subsea cable 301, for example, the energy sink 300 may be coupled to a dynamic portion of the subsea cable 301, and may be configured to mitigate vibration of the subsea cable 301. For example, vibration or kinetic energy may be transferred from the subsea cable 301 to the energy 300 sink using Targeted Energy Transfer (TET). The energy transferred from the subsea cable to the energy sink may be dissipated locally by the energy sink 300 without flowing back to the subsea cable 301. An (e.g., nonlinear) energy sink 300 according to the present disclosure may be capable of absorbing and dissipating vibration energy across various ocean conditions. For example, a (e.g., nonlinear) energy sink 300 according to the present disclosure may dissipate vortex-induced vibration in various ocean conditions.

In accordance with some examples, a non-linear energy sink 300 according to the present disclosure may be a bi-stable non-linear energy sink. For example, a bi-stable non-linear energy sink according to the present disclosure may switch between two stable equilibrium points. For example, the energy sink 300 may switch or jump between the two or more stable equilibrium points based on excitation the subsea power cable 301, for example, when kinetic energy transferred from the subsea power cable 301 to the energy sink 300 exceeds a threshold. According to the present disclosure, the energy sink 300 may naturally return to one of the (e.g., multiple, two) stable equilibrium points or positions after vibration (e.g., kinetic) energy is transferred from the subsea power cable 301 to the energy sink 300.

As described above, a nonlinear energy sink 300 according to the present disclosure may include a clamp 310, a pair of end masses 320, at least one post-buckled bar 330 extending between the pair of end masses 320, and a compressive load assembly 340. The clamp 310 may couple the post-buckled bar 330, the pair of end masses 320, and the compressive load assembly 340 to the subsea cable 301. In accordance with some examples, the clamp 310 may include a brace 311 configured to receive (e.g., at least a portion of) the subsea cable 301, and a rod 312 extending between the brace 311 and at least one post-buckled bar 330. In some examples, as shown in FIG. 3, rod 312 may extend between the brace 311 and a single one or two or more post-bucked bars 330 included in the energy sink 300. In accordance with some examples, the brace 311 may be sleeve or sleeve segment, for example defining a receptacle or opening configured to receive (e.g., at least a portion of) the subsea cable 301. For example, the brace 311 may be configured to receive the subsea cable 301 and engage (e.g., abut) a circumference of the subsea cable 301. After receiving the subsea cable 301, the brace 311 may be tightened, for example, using one or more fasteners (e.g., bolts, screws, nuts, rivets, welding, or the like), such that the subsea cable 301 is maintained or captive within the brace 311.

The clamp 310 may further include a rod 312 extending between the brace 311 and (e.g., at least one of) the post-buckled bars 330. According to the present disclosure, the rod 312 may be disposed perpendicular to one or both of the subsea cable 301 and the post-buckled bar 330. According to the present disclosure, vibration or kinetic energy may be transferred from the subsea cable 301 to the post buckled bar 330 and the pair of end masses 320 via the rod 312. In accordance with some examples, the clamp 310 may be configured to couple the post-buckled bar 330 to the subsea cable 301, such that the post-buckled bar 330 is disposed perpendicular to the subsea cable 301.

In accordance with some examples of the present disclosure, the post-buckled bar 330 and the pair of end masses 320 may form a mass-spring system. In accordance with some examples, as described hereinafter in greater detail, the mass-spring system comprised of the post-buckled bar 330 and the pair of end masses 320 may exhibit nonlinear properties. Particularly, the mass-spring system may exhibit non-linear (e.g., cubic) stiffness.

As noted above, the nonlinear energy sink 300 may include a pair of end masses 320. In some examples, the pair of end masses 320 may be spherical, as illustrated in FIG. 3.

However, the present disclosure is not limited thereto and in other examples, the pair of end masses 320 may have another shape, for example, an ellipsoid, parallelepiped, or another shape. The pair of end masses 320 may have one, or both of: the same shape; or the same mass.

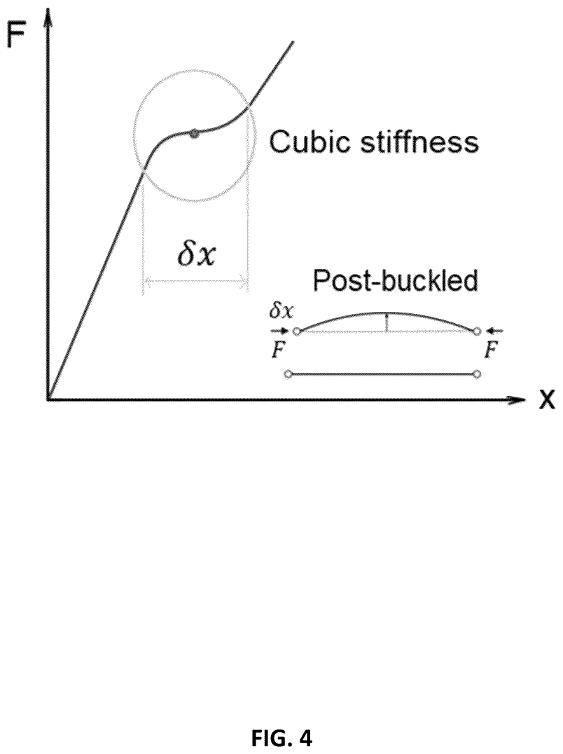

Additionally, the nonlinear energy sink may include a post-buckled bar 330. The post buckled bar 330 may extend between the pair of end masses 320. In some examples, as shown in FIG. 3, the non-linear energy sink may include two or more post-buckled bars 330. As described hereinafter in greater detail, the compressive load assembly may be configured to apply compressive force to the post-buckled bar 330, such that the post-buckled bar 330 is in a “post-buckled” state. The post-buckled state may be a state in which the post-buckled bar 330 has been compressed, such that the bar has undergone buckling. As shown in FIG. 2, the post-buckled bar 330 may have an arcuate or curvilinear shape, for example, the post-buckled bar 330 may form a stable curved shape. FIG. 4 is a graph illustrating the nonlinear stiffness of a post-buckled bar 330 in accordance with one example of the present disclosure.

In accordance with some examples, a nonlinear energy sink according to the present disclosure, for example, non-linear energy sink 300, may be a bi-stable nonlinear energy sink. For example, the nonlinear energy sink may have two stable states. Each of the stable states may correspond to a different stable shape of the post buckled bar. For example, the post buckled bar may have a stable shape went it is bet or deformed the same degree in each of a pair of opposite directions. For example, the post buckled bar may have a first stable shape in which it is bent to be convex and a second stable shape in which in it bent or deformed the same degree in an opposite direction so as to be concave.

The one or more post-buckled bar(s) 330 may exhibit strong non-linear properties, and thus, may impart strong nonlinear properties to a mass-spring system including the post-buckled bar(s) 330. For example, the post-buckled bar(s) 320 may exhibit a non-linear stiffness (e.g., a non-linear load-displacement relationship). The one or more post-buckled bar(s) 320 may exhibit cubic stiffness.

In accordance with some examples, the post-buckled bar(s) 330 (e.g., and thus a mass-spring system including the post-buckled bar) may exhibit bi-stable behavior. That is, the post-buckled bar(s) 330 (e.g., and thus, a mass-spring system including the post-buckled bar) may snap, jump, or change between two stable configurations.

The compressive load assembly 340 may be configured to apply and maintain a compressive force on a bar (e.g., the post-buckled bar(s) 320) such that the bar (e.g., post-buckled bar(s) 320) undergoes buckling. In accordance with some examples, the compressive load assembly 340 may include a segmented shaft 341 including a pair of threaded bolts 342. Each of the pair of threaded bolts 342 may extend from a respective one of the pair of end masses 320. The pair of threaded bolts 342 may extend toward one another. Each of the pair of threaded bolts 342 may be the same length. The segmented shaft may further include a turnbuckle or threaded coupling 343. The turnbuckle or threaded coupling 343 may be secured, (e.g., threadedly coupled) to (e.g., each of) the pair of threaded bolts 342. According to some examples, as shown in FIG. 3, the threaded coupling 343 may include a body 345 and a pair of threaded nuts 346 disposed at opposite ends of the body 345. According to the present disclosure, the pair of threaded nuts 346 may have opposing threads, such that rotation of the threaded coupling 343 changes a length of the segmented shaft 341. For example, rotation of the threaded coupling 343 in a first direction may pull both of the pair of threaded bolts 342 inward (e.g., toward a center of the body 345), decreasing a length of the segmented shaft 341. Further, rotation of the threaded coupling in a second, opposite direction may push both of the pair of threaded bolts 342 outwards, increasing a length of the segmented shaft 341.

In accordance with some examples of the present disclosure, rotation of the threaded coupling 343 may change the length the segmented shaft 341, and thus, the magnitude of the compressive force applied to the one or more post-buckled bar(s) 330. For example, rotation of the threaded coupling 343 in a first direction may increase the length of the segmented shaft 341 and reduce the magnitude of the compressive force applied to the post-buckled bar(s) 330. Additionally, rotation of the threaded coupling 343 in a second or opposite direction may decrease the length of the segmented shaft 341 and increase the magnitude of the compressive force applied to the at least one post-buckled bar 330. Accordingly, the threaded coupling 343 may be used to change deformation of, and thus, the stiffness of the one or more post-buckled bar(s) 330. Accordingly, the threaded coupling 343 may be used to tune or change nonlinear damping properties of a nonlinear energy sink, for example, energy sink 300, including the compressive load assembly 340.

Referring to FIG. 5, a subsea cable system 500 is illustrated in accordance with one example of the present disclosure. As shown in FIG. 5, the subsea cable system 500 may include a subsea cable 510 and a plurality of (e.g., two or more) nonlinear energy sinks coupled to the subsea cable 510. For example, as shown in FIG. 5, the subsea cable system 500 includes a first non-linear energy sink 520, a second non-linear energy sink 530, and a third non-linear energy sink 540 coupled to the subsea cable 510. In accordance with some examples of the present disclosure, as shown in FIG. 5, two or more of the plurality of non-linear energy sinks 520, 530, 540 may be disposed in different orientations. For example, positions at which the nonlinear energy sinks may vary not only axially along a length of the, but also radially around the subsea cable 510. Particularly, as shown in FIG. 5, the first nonlinear energy sink 520 and the second nonlinear energy sink 530 may be offset 90 degrees from one another, radially about a center or longitudinal axis of the subsea cable 510. Similarly, the second nonlinear energy sink 530 and the third nonlinear energy sink 540 may be offset 90 degrees from one another, radially about a longitudinal axis of the subsea cable 510. According to the present disclosure, a pair of nonlinear energy sinks (e.g., a combination of two of the first non-linear energy sink 520, the second nonlinear energy sink 530, and the third non-linear energy sink 540) may be coupled to the subsea cable 510, the pair of or two nonlinear energy sinks are offset, for example, radially about a longitudinal axis of the subsea cable 510 in a range of 60 to 120 degrees from one another. According to some examples, the two or more nonlinear energy sinks may be coupled to a subsea cable in different orientations, so as to more effectively mitigate vibration of the subsea cables, for example, to more effectively mitigate vibration of the subsea cable 510 occurring about multiple axes.

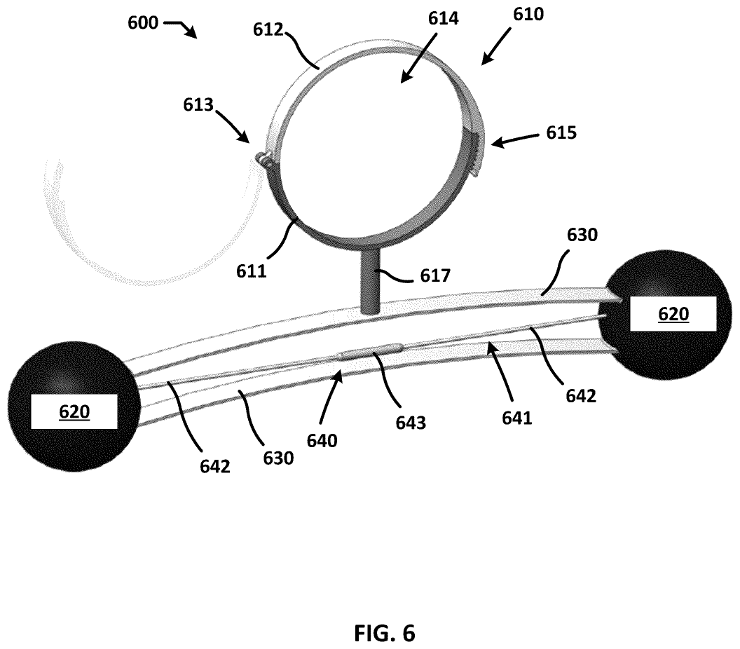

FIG. 6 illustrates a nonlinear energy sink 600 in accordance with another example of the present disclosure. The nonlinear energy sink 600 may include a clamp 610, a pair of end masses 620, a pair of post-buckled bars 630 extending between the pair of end masses 620, and a compressive load assembly 640. The pair of end masses 620, pair of post-buckled bars 630, and compressive load assembly 640 may be the same as or substantially similar to the pair of end masses 320, the at least one post buckled bar 330, and the compressive load assembly 340, respectively, described above with respect to FIG. 3. For example, the compressive load assembly 640 may include a segmented shaft 641 including a pair of threaded bolts 642 and a threaded coupling 643. The segmented shaft 641, pair of threaded bolts 642, and threaded coupling 643 may be the same as the segmented shaft 341, pair of threaded bolts 342, and threaded coupling 343, respectively, described above with respect to FIG. 3.

In accordance with some examples, as shown in FIG. 6, the pair of post-buckled bars 630 may have an elongated rectangular cross sectional shape. For example, a cross sectional width may be any of at least two times, at least three times, or at least four times greater than a cross sectional height of a respective one of the pair of post-buckled bars 630. According to the present disclosure, inclusion of one or more post-buckled bars 630 including an elongated rectangular cross sectional shape may improve the vibration mitigation and energy dissipation performance of the nonlinear energy sink 600, for example, compared to post-buckled bars having a symmetrical (e.g., square, circular) cross sectional shape.

Still referring to FIG. 6, the nonlinear energy sink 600 may include a clamp 610 configured to receive a portion of a subsea cable for coupling the nonlinear energy sink 600 to the subsea cable. For example, the clamp 610 may facilitate coupling or retrofitting the nonlinear energy sink 600 onto existing (e.g., already installed) subsea power cables without requiring the subsea power cable to be removed from the body of water in which the subsea power cable is installed. For example, the clamp 610 may facilitate underwater installation of the nonlinear energy sink 600 on existing subsea power cables by a diver and/or remotely operated vehicles (ROVs).

As shown in FIG. 6, the clamp 610 may include a pair of arcuate segments hingedly coupled to one another. Particularly, the clamp may include a first arcuate segment 611, a second arcuate segment 612, and a hinge 613 disposed between and hingedly coupling the first arcuate segment 611 and the second arcuate segment 612. According to some examples, as shown in FIG. 6, the first arcuate segment 611 and the second arcuate segment 612 may have a semicircle shape. The first arcuate segment 611 and the second arcuate segment 612 may be hingedly coupled to one another, such that the first arcuate segment 611 and the second arcuate segment 612 are free to move or pivot between an open arrangement and closed arrangement in which the first arcuate segment 611 and the second arcuate segment 612 interlock, defining an opening 614 encircled or circumscribed by the pair of arcuate segments 611, 612. As shown in FIG. 6, the opening 614 formed by the first arcuate segment 611 and the second arcuate segment 612 disposed in the closed arrangement may have a circular shape.

In one or some examples, as shown in FIG. 6, the first arcuate segment 611 and the second arcuate segment 612 may collectively define a jagged pattern lock 615 configured to lock the first arcuate segment 611 and the second arcuate segment 612 in the closed arrangement, with the subsea cable securely disposed within the opening 614, and the first and second arcuate segments 611, 612 encircling the subsea cable. For example, as shown, the jagged pattern lock 615 may include corresponding (e.g., mating) alternating ridges and groves formed along a portion of the exterior surface of the first arcuate segment 611 and along a corresponding portion of the interior surface of the second arcuate segment 612. The jagged pattern lock 615 may ensure that the first arcuate segment 611 and the second arcuate segment 612 remain securely attached to the subsea cable in dynamic sea environments. According to the present disclosure, the clamp 610 may further include a rod 617 extending between the first arcuate segment 611 and one of the pair of post-buckled bars 630.

In accordance with some examples, the first arcuate segment 611 and the second arcuate segment 612 may be composed of different materials. For example, the first arcuate segment 611 may be composed of a first material which is more stiff than a second material of which the second arcuate segment 612 is composed. Similarly, the second material may be more ductile than the first material. Particularly, the first arcuate segment 611 which is (e.g., directly) connected to one of the pair of post buckled bars 630 by the rod 617, may be comprised of the same material as the pair of post buckled bars 630, for example, steel, ensuring structural integrity and compatibility with the damping system. Conversely, the second arcuate segment 612 may be comprised of a more ductile material facilitating effective engagement and locking of the jagged pattern lock 615.

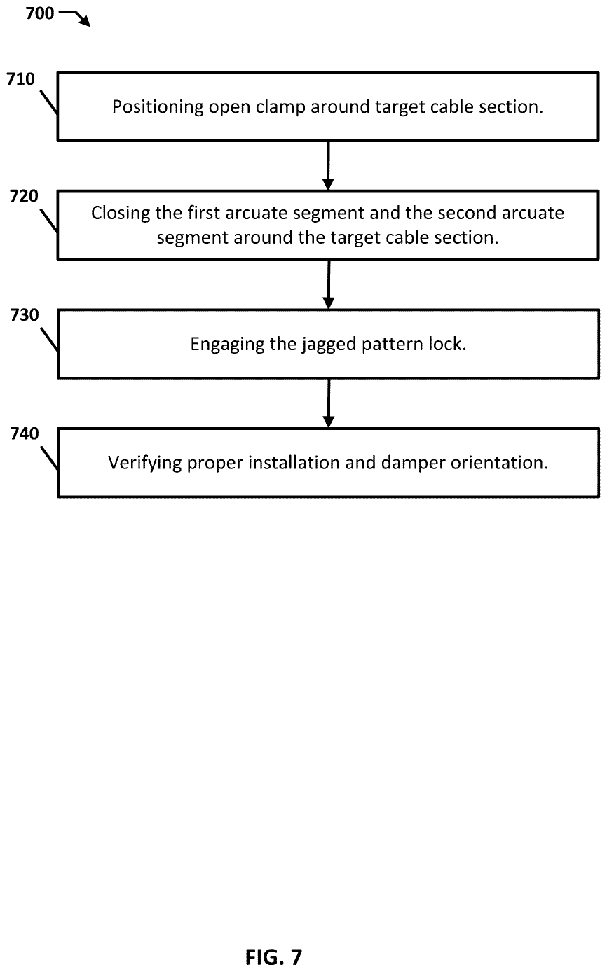

FIG. 7 illustrates a flowchart 700 for coupling a nonlinear energy sink to a subsea cable in accordance with one example of the present disclosure. For example, the flowchart 700 may be used to couple the nonlinear energy sink 600 illustrated and described above with respect to FIG. 6 to a subsea cable. Different, additional, or fewer acts may be provided.

In an act 710, an open clamp, for example, the clamp 610 illustrated and described above with respect to FIG. 6 may be positioned around a target cable section. For example, the open clamp may include a pair of arcuate segments (e.g., first and second arcuate segments) disposed in an open arrangement. According to the present disclosure, act 710 may be performed by a diver, by a remotely operated vehicle, or by an autonomous vehicle.

In an act 720, the clamp may be closed around the target cable section. For example, the pair of arcuate segments may be move from an open arrangement to a closed arrangement in which the pair of arcuate segments encircle the subsea cable. According to the present disclosure, act 720 may be performed by a diver, by a remotely operated vehicle, or by an autonomous vehicle.

In an act 730, a jagged pattern lock, for example, jagged pattern lock 615 as illustrated and described above with respect to FIG. 6, may be engaged. For example, as the pair arcuate segments are move to the closed arrangement the portion of the jagged pattern lock included on a first arcuate segment and the portion of the jagged pattern lock included on the second arcuate segment may engage one another, such that the jagged pattern lock is engaged and the subsea power cable is locked or secured within the opening of the clamp.

In an act 740, proper installation and damper orientation may be verified. For example, damper installation and orientation may be verified by any of a diver, a remotely operated vehicle, or an autonomous vehicle.

### Modeling of a Subsea Dynamic Power Cable

Provided below is a detailed discussion of how computer modeling and analysis techniques may be used for studying the dynamics of a subsea power cable with or without a bi-stable non-linear energy sink (B-NES) attached. First, the numerical simulation framework employed is introduced, followed by the analytical and numerical approaches used to model the system's behavior. These results serve as the foundation for validating the numerical simulations and comparing them with analytical derivations to ensure accuracy and effectiveness in real-world applications.

The lumped-mass mooring model MoorDyn may be used for the simulation of the subsea dynamic power cable and the B-NES device. MoorDyn is an open-source time-domain mooring dynamics library integrated into numerous floating renewable energy simulators, including the National Renewable Energy Laboratory's floating wind turbine simulation tool OpenFAST. MoorDyn has the capability to model rigid-body dynamics, shared mooring lines, line failures, and dynamic power cables. MoorDyn has four core objects that can be used to construct a mooring system: lines, points, rods, and bodies.

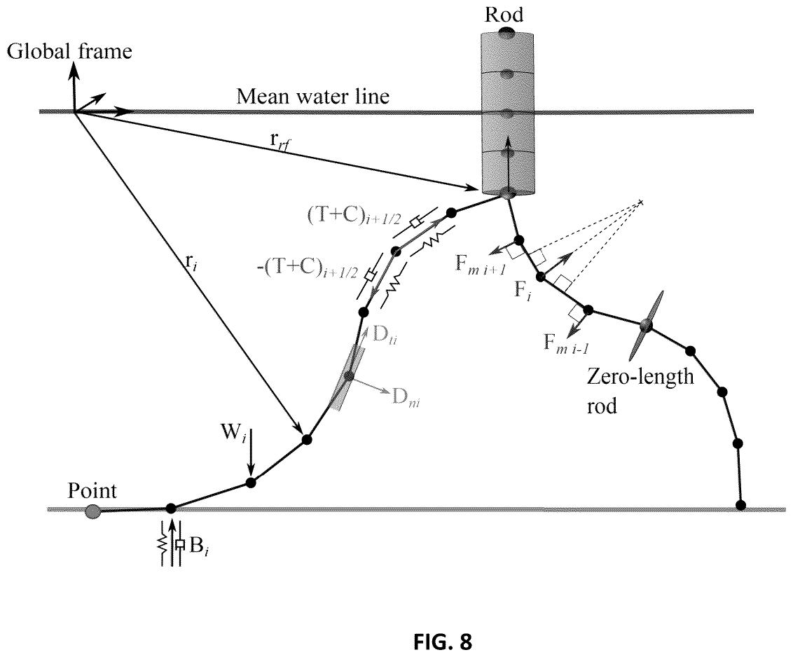

FIG. 8 illustrates a schematic of the MoorDyn lumped mass model in accordance with one example of the present disclosure. As shown in FIG. 8, MoorDyn employs lumped-mass discretization to represent mooring lines as point masses connected by linear spring-damper segments, which allows for elasticity in the axial direction. If rᵢ and rᵢ₊₁ represent the absolute position vectors of two adjacent nodes, the strain

$${e}_{i + \frac{1}{2}}$$

in the segment connecting them may be determined using equation 2:

$${e}_{i + \frac{1}{2}} = ( \frac{\vert {r}_{i + 1} - {r}_{i} \vert}{l} - 1 ) \qquad Eq . 2$$

where l is the unstretched segment length. The tangent direction at a node i may be approximated as a unit vector aligned between the nodes on either side using equation 3:

$${\hat{q}}_{i} = \frac{{r}_{i + 1} - {r}_{i - 1}}{\vert {r}_{i + 1} - {r}_{i} \vert} \qquad Eq . 3$$

The tension force acting on each segment, denoted by

$${T}_{i + \frac{1}{2}}$$

(due to material stiffness) and by

$${C}_{i + \frac{1}{2}}$$

(due to internal damping), may then be computed using equations 4 and 5, respectively:

$${T}_{i + \frac{1}{2}} = E \frac{π}{4} {d}^{2} {e}_{i + \frac{1}{2}} * {\hat{q}}_{i} \qquad Eq . 4$$

$${C}_{i + \frac{1}{2}} = {C}_{int} \frac{π}{4} {d}^{2} \frac{\partial {e}_{i + \frac{1}{2}}}{\partial t} * {\hat{q}}_{i} \qquad Eq . 5$$

where d is the line diameter, E the elasticity modulus, and Cᵢₙₜ the internal damping coefficient.

The strain rate of the segment

$$\frac{\partial {e}_{i + \frac{1}{2}}}{\partial t}$$

may be calculated using equation 6:

$$\frac{\partial {e}_{i + \frac{1}{2}}}{\partial t} = \frac{\partial }{\partial t} ( \frac{\vert {r}_{i + 1} - {r}_{i} \vert}{l} - 1 ) \qquad Eq . 6$$

Structural damping may be introduced to critically damp non-physical resonances arising from segment discretization. External forces are also accounted for in MoorDyn, including hydrodynamics and seabed interactions. Hydrodynamic forces such as drag and added mass are incorporated using the Morison equation.

Dynamic cables can be modeled in MoorDyn as line objects with a non-zero bending stiffness term. Zero-length rods are used as 6 degree of freedom (DOF) points to attach the cable to other objects such as other cables and bodies so that bending moments due to cable motion are properly accounted for. This method of cable modeling in MoorDyn is frequently used by users and was verified in the original cable implementation study. In the absence of rotational DOFs to MoorDyn's line nodes, a bending moment is implemented by applying transverse forces on the nodes, perpendicular to the axial stiffness forces. The bending moment at a given location along the line is calculated as M=EIk, where EI is the cable's bending stiffness (the product of the elasticity modulus and cross-sectional moment of inertia) and k is the local cable curvature. The curvature k at node i may be defined using equation 7:

$${κ}_{i} = \frac{2}{dl} \sqrt{1 - {\hat{q}}_{i - \frac{1}{2}} \cdot {\hat{q}}_{i + \frac{1}{2}}} \qquad Eq . 7$$

where dl is the unstretched cable length between adjacent nodes and

$${\hat{q}}_{i - \frac{1}{2}} and {\hat{q}}_{i - \frac{1}{2}}$$

are the unit tangent vectors between nodes. The bending moment can then be represented as a set of forces on the nodes and their neighboring nodes. Unit vector bi is the axis of curvature at node i and may be expressed using equation 8:

$${b}_{i} = \frac{{\hat{q}}_{i - \frac{1}{2}} \times {\hat{q}}_{i + \frac{1}{2}}}{\vert {\hat{q}}_{i - \frac{1}{2}} \times {\hat{q}}_{i + \frac{1}{2}} \vert} \qquad Eq . 8$$

The forces may be applied to nodes i−1 and i+1 to create the bending moment across node i, with the magnitudes given by equations 9 and 10, respectively.

$${F}_{m , i - 1} = \frac{M}{dl} \cdot ( {\hat{q}}_{i - \frac{1}{2}} \times {b}_{i} ) \qquad Eq . 9$$

$${F}_{m , i + 1} = \frac{M}{dl} \cdot ( {\hat{q}}_{i + \frac{1}{2}} \times {b}_{i} ) \qquad Eq . 10$$

Because these forces are applied to the adjacent nodes, they give rise to a non-physical net force at node i, which, in turn, is neutralized by an opposing force applied to node i, which may be expressed using equation 11:

Fᵢ=−(F_{m,i-1}+F_{m,i+1}) Eq. 11

This approach allows for bending stiffness to be included in MoorDyn line objects without any change to the line state vector or other load calculations.

The final integrated equation of motion for each node of the subsea cable, accounting for the node mass and other forces such as tension, damping, and drag, is expressed using equation 12:

$$( {m}_{i} + {a}_{i} ) \frac{{\partial }^{2} {r}_{i}}{\partial {t}^{2}} = {T}_{i + \frac{1}{2}} - {T}_{i - \frac{1}{2}} + {C}_{i + \frac{1}{2}} - {C}_{i - \frac{1}{2}} + {F}_{i} + {W}_{i} + {B}_{i} + {D}_{ni} + {D}_{ti} \qquad Eq . 12$$

where Wᵢ is the submerged weight, Bᵢ is the bottom contact force, and Dₙᵢ and Dₜᵢ are the normal and tangential drag forces, respectively. Lastly, mᵢ is defined as the 3×3 identity matrix multiplied by the mass of the node, whereas aᵢ is the 3×3 added-mass matrix.

Points are 3-DOF objects used to connect lines to each other, the platform, or the seabed. They can have mass and volume, allowing them to simulate things like clump weights and floats. They follow the same kinematic theory as line nodes and have external forcing from hydrodynamics and any attached lines.

Rod objects are similar to lines in that they use a lumped-mass approach, but the masses are rigidly connected along a central axis. Zero-length rods may be modeled as a 6-DOF point object for passing bending moments from dynamic cables to their attached object. A key implementation step for rod objects is lumping the forces and masses at each node along the rod length into a single set of 6-DOF forces and mass coefficients at the rod reference point. To lump forces, the point force vectors fᵢ at each node i along the rod are combined into a single force and moment vector f₆ at the rod reference point (end A) using equation 13:

$${f}_{6} = {\sum }_{i} ( \begin{matrix}{f}_{i} \\ {f}_{i} ( ( {r}_{i} - {r}_{rf} \times {f}_{i} ) )\end{matrix} ) \qquad Eq . 13$$

where rᵢ represents the global position for each node and r_{rf} is the reference point for the rod.

For transforming the mass of an object to a new reference position r′, equations 14 and 15 may be used:

$${M}^{′} = {\sum }_{i} {M}_{i} \qquad Eq . 14$$

$${I}^{′} = {\sum }_{i} ( {M}_{i} {H}_{i} {H}_{i}^{T} + {H}_{i} {I}_{i} {H}_{i}^{T} + {J}_{i} ) \qquad Eq . 15$$

where H is the matrix of antisymmetric tensor components, defined as Hᵢⱼ=∈ᵢⱼₖ dₖ in which d=r′−r and ∈ is the Levi-Civita (permutation) symbol.

Bodies are more general 6-DOF objects that can have rods and points attached to them. They can be used to simulate the rigid-body dynamics of a platform or attach the other objects rigidly. The dynamics of the system consider both forces and mass contributions from the rods and other attached objects. Key properties of body objects include mass and center of mass; volumetric displacement (assumed to be at the reference point); moment of inertia about each axis; hydrodynamic drag coefficients for each direction; and added-mass coefficients for each direction.

These parameters enable the simulations of even complex dynamics, such as rotations and translations within the mooring system, capturing both hydrodynamic and mechanical interactions. Points, rods, and bodies can all move freely or be coupled to an external program that drives their motions. During runtime, the equations of motions of these objects are all integrated to advance each time step using different user-specified integrators, such as Runge-Kutta 2 or 4.

Using the open-source MoorDyn library, we implemented a dynamic cable simulation to model a vertical cable running from a platform to the seabed. For this simulation, we introduced multi-harmonic excitation by applying prescribed motions to the platform. We implemented a subsea power cable model and selected the following cable parameters as an example to showcase the implementation of the B-NES devices. The cable had a diameter of 0.076 m and a mass density in air of 4.73 kg/m. The axial stiffness (EA) is set to 9 MN, and the bending stiffness (El) of the cable is set to 11.71 kN-m². The added-mass coefficients, normal to the cable (Can), are equal to 1.0 and describe the influence of the surrounding water on the cable's inertia. The hydrodynamic drag coefficients, both normal (Cdn) and tangential (Cdt), are 1.2 and 0.008, respectively. This comprehensive setup allows us to simulate the dynamic behavior of the cable, including the effects of axial and bending stiffness, internal damping, seabed contact, and hydrodynamic drag, ensuring that the cable's response to multi-harmonic excitation is accurately modeled.

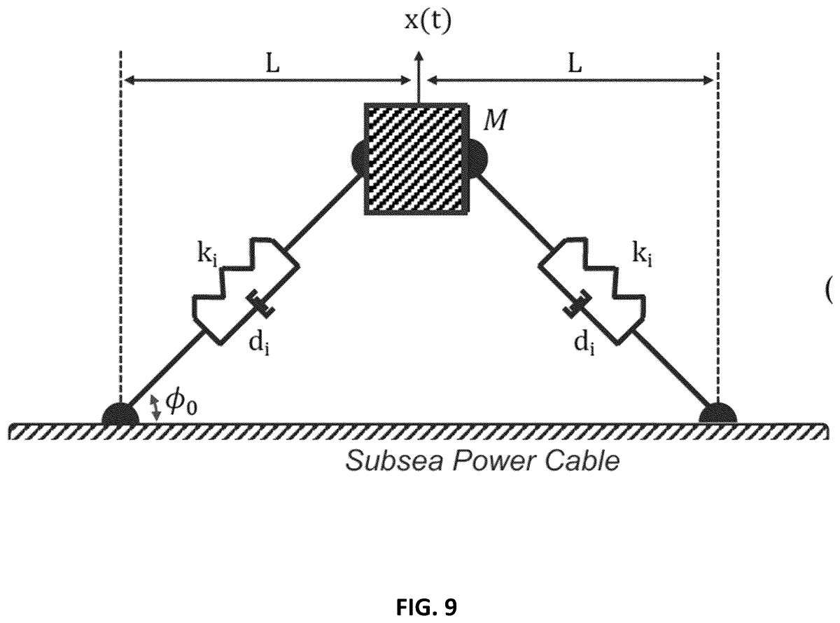

FIG. 9 illustrates a schematic representation of the relative displacement of a bi-stable non-linear energy sink mass with respect to the cable. The analytical modeling of the B-NES integrated into a subsea dynamic power cable involves characterizing the dynamic responses of the B-NES to external excitations. A reduced-order model of the B-NES was created in the form of a nonlinear single-DOF system that consists of a mass that is connected to the subsea cable through two inclined spring-damper pairs with nominal stiffness kᵢ and damping coefficient dᵢ. The inclined elements are set at an initial angle of inclination Ø₀ relative to the point of attachment to the cable when the system is at rest, and it is assumed that these inclined elements are unstretched at equilibrium. Even though the spring and damper elements are linear in the analytical modeling, strong geometric nonlinearity is generated during the oscillation of the mass of the B-NES.

Referring to FIG. 9, the mass M of the B-NES is connected by the inclined springs and dampers to the cable through a rod, which allows for adjustments of the initial angle of inclination Ø₀, i.e., the angle of inclination at the equilibrium position of the B-NES. This connection directly affects the system's bi-stable nonlinear behavior. This angle significantly influences the response of the B-NES, as the natural length L of the inclined springs depends on this angle. In this configuration, the geometric nonlinearity enhances vibration mitigation by introducing bi-stability into the dynamics. Assuming that a disturbance (unwanted vibration) is applied to the cable, that the mass M of the B-NES executes vibrations in a direction that is orthogonal to the cable, and that its relative deflection (with respect to the local motion of the cable) is x(t), the nonlinear vibration of the B-NES is governed by differential equation 16:

M(\ddot{x}+\ddot{x}_{cable})+Fₛᵢ(x)+F_{di}(x,\dot{x})=0 Eq. 16

where x_{cable} denotes the local motion of the cable at the points of attachment to the bi-stable nonlinear energy sink, Fₛᵢ(x) the stiffness force exerted by the inclined springs, and F_{di}(x,\dot{x}) the dissipative force generated by the inclined viscous dampers. Fₛ and F_{di} may be determined using equations 17 and 18, respectively:

$${F}_{s} = 2 {k}_{i} ( 1 - \frac{L sec ( {ϕ}_{0} )}{\sqrt{{L}^{2} + {y}^{2}}} ) y \qquad Eq . 17$$

$${F}_{di} = 2 {d}_{i} \frac{{yy}^{2}}{{L}^{2} + {y}^{2}} \qquad Eq . 18$$

where y=x+L tan Ø₀.

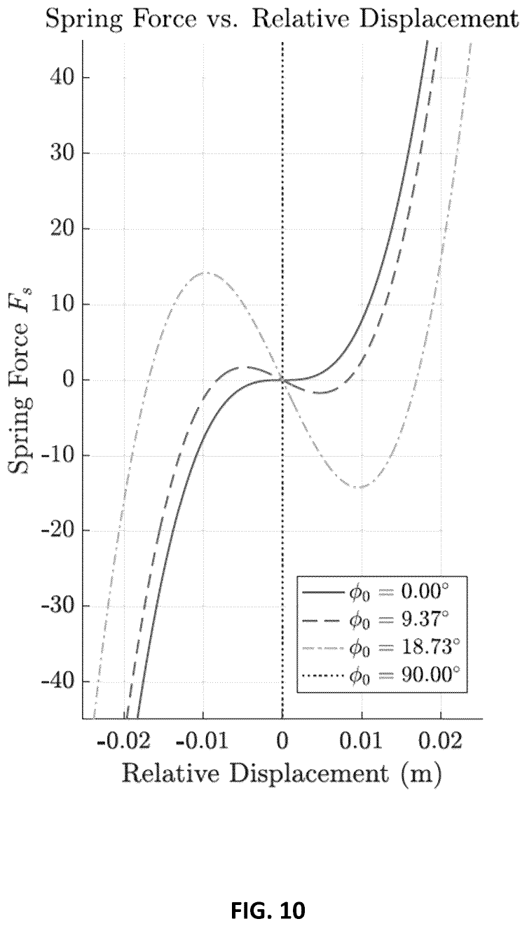

FIG. 10 is a graph illustrating tunability of non-linear stiffness of a bi-stable nonlinear energy sink. As shown in FIG. 10, depending on the angle of inclination at equilibrium Ø₀, we can achieve different stiffness nonlinearities in the B-NES, as shown in FIG. 2b, where the nonlinear stiffness force Fₛᵢ is plotted as a function of the relative displacement of the B-NES with respect to the cable to which it is attached; for these plots we considered the system parameters, as follows, M=0.1 Kg, kᵢ=2×10 C N/m, dᵢ=0.25 Ns/m, L=0.05 m, and different initial angles of inclination Ø₀. Note that above a certain critical threshold of Ø₀, we achieve bi-stability, i.e., two non-trivial stable equilibrium positions, with the trivial equilibrium in between being unstable. The oscillations of the mass between the two stable equilibria generate strong stiffness nonlinearity which, as shown below, is the source of the drastically enhanced vibration mitigation performance of the B-NES compared to the classical linear TMD.

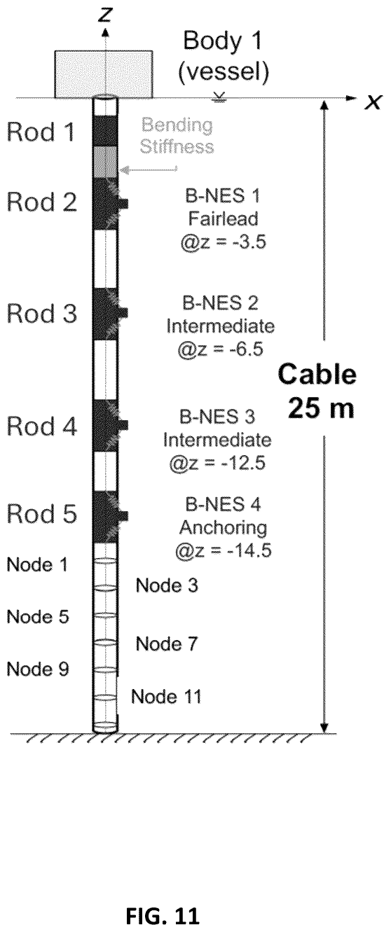

In the following exposition, we incorporate the numerical model of the B-NES within MoorDyn and compare it to the previous analytical derivation in order to validate our modeling approach. Specifically, four B-NESs are attached to a vertical subsea cable, as shown in FIG. 11. The cable was modeled as a lumped-mass system, and each B-NES was attached to it using a single rod element to maintain the desired angle of inclination, which is crucial for achieving bi-stability. The bi-stability is simulated numerically by adjusting the rod's length to alter the angle of inclination. Instead of the inclined linear springs, we modeled the elastic connections of the B-NES to the cable as linear elastic cords in-tension within MoorDyn, which introduces substantial nonlinearity through geometric and kinematic effects, as shown in FIG. 9. The bi-stability is manipulated by varying the ratio of the natural lengths of the springs relative to the rod length: The smaller this ratio is, the greater the angle of inclination becomes, thus enhancing the bi-stable feature, as evidenced in the corresponding force-deflection stiffness characteristic of the B-NES (see FIG. 10).

The unique aspect of this setup is the clearance effect introduced by the linear inclined elastic cords in-tension, which do not exert force unless the displacement of the B-NES mass relative to its attachment point exceeds their natural lengths. This feature introduces a significant nonlinearity that allows for the exploration of rich dynamics. The rod at the base of the B-NES is aligned along the cable, with the B-NES mass permitted to move in a perpendicular direction with respect to the cable segment to which it is attached. This setup paves the way for deriving analytical solutions to validate the numerical model's predictions. To ensure valid comparisons across different models, we adjusted the cable's mass density to uniformly distribute mass and negate any added-mass effects when comparing baseline scenarios with and without the addition of the B-NES devices. These comparisons have confirmed that the introduction of the rod element has minimal impact by ensuring consistent fairlead tensions across all tested configurations.

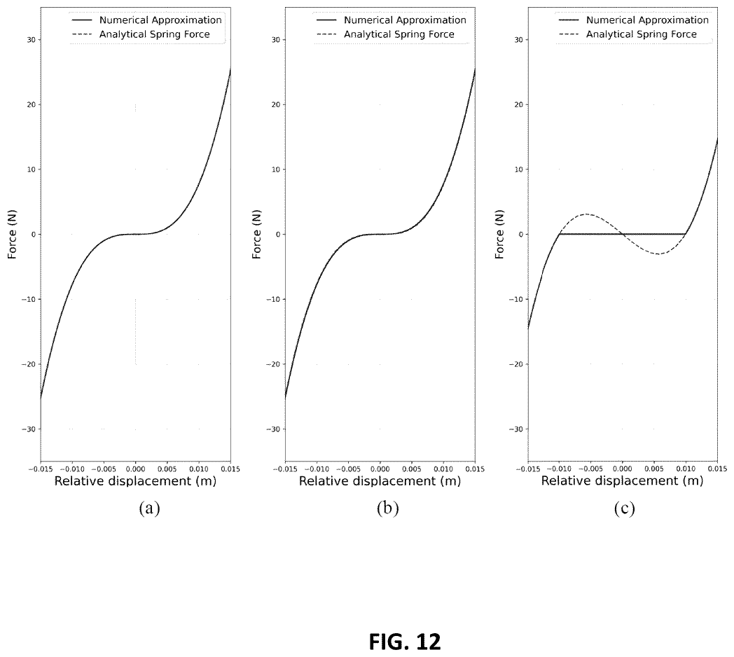

FIG. 12 illustrates force versus displacement curves for multiple numerical model simulations. The various curves of FIG. 12 demonstrate the analytical versus numerical results of the nonlinear force deflection characteristics of the B-NES device for the applied system parameters, and three different initial angles of inclination Ø₀. More specifically, in curve (a) of FIG. 12, we consider the nonlinear stiffness of the B-NES with zero angle of inclination, where we have a realization of pure cubic stiffness nonlinearity due to the relative transverse motion of the B-NES mass in the orthogonal direction with respect to the subsea cable segment to which it is attached. In curves (b) and (c) of FIG. 12, we increase the initial angle of inclination by adjusting the length of the attaching rod to a resulting angle of inclination equal to Ø₀=2° and Ø₀=11.48°, respectively. As expected, the results differ in the regime where the inclined cords are slack. Because they do not exert any force on the cable, the bi-stable behavior yields a sudden transition (“jump”) between the two non-trivial stable equilibrium positions. This result also shows the difference between our numerical modeling, which is based on the inclined cords-in-tension within MoorDyn, and the analytical model (equation 18), which is based on linear springs. We note, however, that the “jumps” that we achieve in the MoorDyn model add extra-strong nonlinearity in the dynamics of the B-NES and emphasizes even more its bi-stability behavior; as such, the resulting non-smooth effects in the dynamics of the B-NES play an even more beneficial role for vibration mitigation.

An advanced data-driven methodology is developed to optimize the operational performance of the NES for dynamic stabilization of the subsea power cable. This discourse elucidates an exhaustive optimization strategy, from computational configurations to the rigorous assessment of performance indices, all underpinned by advanced High Performance Computing (HPC) resources.

At the core of our computational strategy is the utilization of the Hardware-Accelerated Learning (or HAL) cluster, an HPC cluster at the University of Illinois Urbana-Champaign, which is thoroughly engineered to facilitate the demanding computational tasks that are inherent to the present research task. Contrary to conventional parallel computations performed on standard desktop configurations, our approach leverages 96 CPUs, thereby substantially diminishing the computational latency for scenarios characterized by high mechanical stiffness of the B-NES. This computational efficiency is decisive given the extensive parameter space and the large volume of simulations—exceeding 10,000 discrete evaluations—necessary to thoroughly canvass and optimize the potential configurations of the B-NES. For efficient management and distribution of the simulation tasks across the HPC infrastructure, we employ the SLURM job scheduling system. This system not only optimizes the allocation of computational resources but also guarantees that each simulation is executed under stringent and reproducible conditions, crucial for the empirical validity of our results.

The optimization methodology adopted in this work encompasses a detailed parametric study, systematically varying critical properties of the B-NES—such as stiffness, damping characteristics, and mass—to detect configurations that deliver optimal vibration suppression efficacy. This process is facilitated by the application of HPC simulations integrated with a Python toolkit based on the code MoorPy, designed to streamline file operations and preprocessing for MoorDyn simulations. In our optimization framework, we explore both isolated and multiple B-NES configurations attached at different positions along the subsea cable, particularly focusing on zones of the cable identified as high risk for structural failure. We strategically position multiple B-NES devices near the fairlead—where the cable connects to the platform, a juncture deemed critical for cable integrity. In our simulations, we consider multi-harmonic pulse (transient) excitations imposed by platform motion, thereby enabling early interception of vibrational energy by the B-NES positioned near the excitation source, with the aim of mitigating cable vibration amplitudes before the vibration disturbance can propagate further down along the cable. Further, we deploy additional B-NESs at antinodes of cable modes where oscillation amplitudes are expected to peak, thereby impacting not only the local but also the global dynamics of the cable, as observed in extensive simulation trials. To optimize the performance of the B-NESs, we adjust the axial stiffness parameters corresponding to the stiffnesses of the cords-in-tension of various B-NES configurations implemented along the cable's length. Accompanying these adjustments, proportional damping in the cords-in-tension is modulated in accordance with stiffness variations to maintain model fidelity. Throughout these simulations, the additional mass effect to the cable (due to augmentation of the cable by the B-NESs) is rigorously accounted for by equating the total masses of the baseline cable configuration (i.e., the cable with no B-NES attached) and the cable with NESs attached.

A comprehensive suite of simulations facilitates the implementation of B-NES design, optimizing device performance across varying excitation frequencies and amplitudes. Concurrently, we define three quantitative performance metrics to rigorously evaluate device efficacy: (i) The Δ (Delta) measure, reflecting kinetic energy changes in the subsea cable induced by the B-NESs; (ii) The Γ (Gamma) measure, assessing the corresponding potential energy changes in the cable; and (iii) The settling time t, quantifying the rate at which the B-NESs dissipate the vibrational energy of the subsea cable. These metrics, which are presented in detail below and are derived from detailed mathematical formulations and empirical observations, enable the precise assessment of the performance of the B-NESs on cable dynamics subject to varying operational conditions. This optimization approach, supplemented by logarithmic scaling of parameter variations (to account for large disparities in the B-NES parameter values), provides a robust framework for identifying optimal B-NES configurations through a systematic and exhaustive exploration of performance landscapes, culminating in a Pareto-optimal selection strategy that aligns the B-NES system parameters to specific operational requisites.

The first metric, Δ, monitors the reduction in kinetic energy of the cable due to the action of the attached B-NESSs. This metric is defined using equation 19:

$$Δ = \frac{{\sum }_{i = 1}^{N} \frac{1}{2} {\int }_{{t}_{0}}^{{t}_{1}} {m}_{i} \frac{{{dx}_{CN}^{i} ( t )}^{2}}{dt} dt}{{\sum }_{i = 1}^{N} \frac{1}{2} {\int }_{{t}_{0}}^{{t}_{1}} {m}_{i} \frac{{{dx}_{C}^{i} ( t )}^{2}}{dt} dt} \qquad Eq . 19$$

where mᵢ is the mass of the i-th (discretized) segment of the cable, and

$${x}_{c}^{i} ( t ) and {x}_{cn}^{i} ( t )$$

denote the corresponding deflections of the node of the cable with and with the NESs attached, respectively. The time integrations in the numerator and denominator are carried out for the time window of the response t∈[t₀, t₁]. It follows that this positive measure can be used to assess how the action of the B-NESs affects the kinetic energy of the cable. Clearly, the smaller Δ is, the more effective the B-NESs become in reducing the kinetic energy of the cable. Similarly, the second performance metric Γ measures the reduction in potential energy of the cable when the B-NES are added and is defined using equation 20:

$$Γ = 1 - \frac{{\sum }_{i = 1}^{N} \frac{1}{2} {\int }_{{t}_{0}}^{{t}_{1}} {{x}_{CN}^{i}}^{2} dt}{{\sum }_{i = 1}^{N} \frac{1}{2} {\int }_{{t}_{0}}^{{t}_{1}} {{x}_{C}^{i}}^{2} dt} \qquad Eq . 20$$

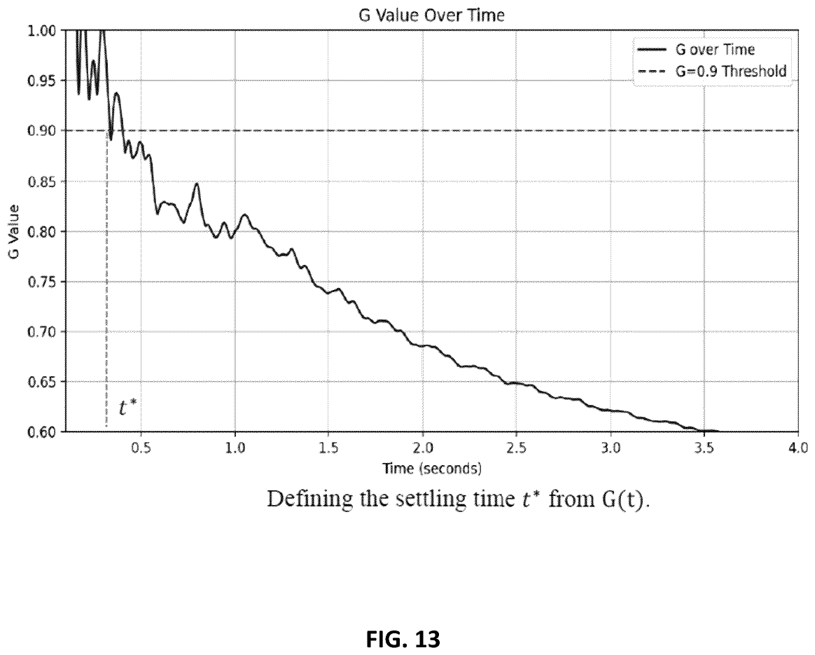

FIG. 13 illustrates setting time t* in accordance with one example of the present disclosure. The settling time t* is a measure of that quantifies how fast the B-NESs manage to dissipate the vibrational energy of the subsea cable. This measure is defined as the time t=t* when measure G(t) is defined using equation 21:

$$G ( t ) = 1 - \frac{{\sum }_{i = 1}^{N} \frac{1}{2} {\int }_{{t}_{0}}^{{t}_{1}} {{x}_{CN}^{i}}^{2} dt}{{\sum }_{i = 1}^{N} \frac{1}{2} {\int }_{{t}_{0}}^{{t}_{1}} {{x}_{C}^{i}}^{2} dt} \qquad Eq . 21$$

where G(t) decreases for the first time to the value G(t*)=0.9, i.e., when the integral of the potential energy of the cable with the B-NES reaches 10% of the corresponding integral for the cable with non attached B-NESs for the first time.

In the optimization, we utilize logarithmic scaling for the parameter variation, which is more effective than linear scaling when exploring parameter ranges that are orders of magnitude apart. In the optimization procedure, four B-NESs were strategically placed along the length of the subsea cable to provide vibration mitigation at critical points; these devices are categorized into three types: Fairlead, Intermediate-Antinode, and Anchoring (see FIG. 11). The Fairlead B-NES 1, positioned closest to the platform, is followed by the Intermediate-Antinode B-NESs 2 and 3, with the Anchoring B-NES 4 located at the end of the cable. This arrangement ensures that the B-NESs are positioned at vital locations along the cable, offering enhanced protection to key points. The prescribed multi-harmonic transient motion of the platform may be given by equation 22:

F(t)=A sin ωt÷A sin 2ωt+A sin 4ωt,t≤0.5s

F(t)=0,t>0.5s Eq. 22

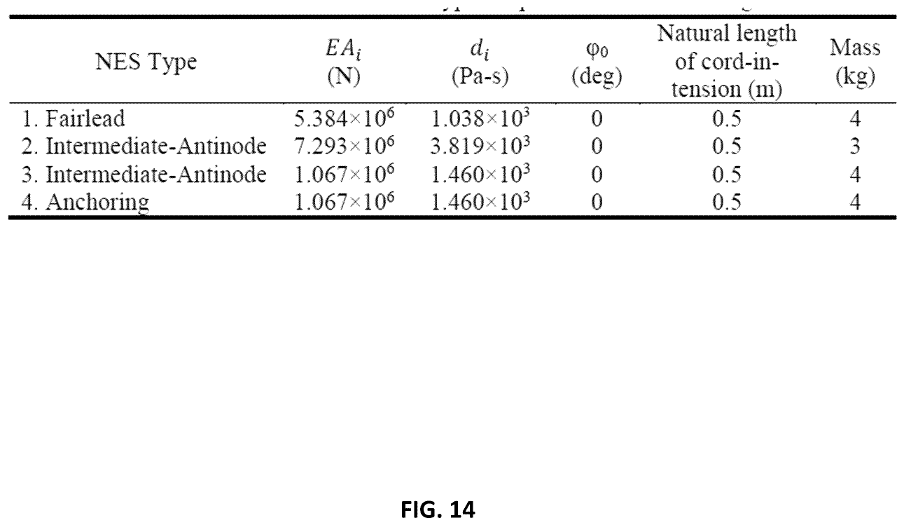

with ω=2πf, f=2 Hz, A=0.01 m. A total of 2,000 simulations were performed to optimize the three types of B-NESs attached to the subsea cable. The optimization considered the variations in the axial stiffnesses EAᵢ, i=1, 2, 3, of the inclined cords-in-tension of the three B-NES types (because these are key parameters) in the range EAᵢ∈[10⁴N, 5×10¹⁰ N]. The remaining B-NES parameters (angle of inclination, natural lengths of the cords, and mass) were kept fixed, as listed below in FIG. 14.

We note that the selected angle of inclination of Ø₀=3.562° is greater than the bifurcation value for bi-stability, which in this case is Ø_{0,bif}=0.22° as predicted by the analytical formula derived in; this guarantees that all four B-NESs possess the bi-stability feature (this is also verified by the numerical transient responses that follow). Moreover, we note that the mass of B-NES 1 was taken as 4.5% of the total cable mass, the masses of B-NES 2 and 3 as 3.5% and 4.5% of the cable mass respectively, and the mass of B-NES 4 as 4.5% of the cable mass (see FIG. 11). Proportional damping was considered in the cords-in-tension, so the coefficients of the inclined viscous dampers were taken always proportional to the respective axial stiffnesses of the cords in the range [4.472 Pa−s, 9,999.7 Pa−s].

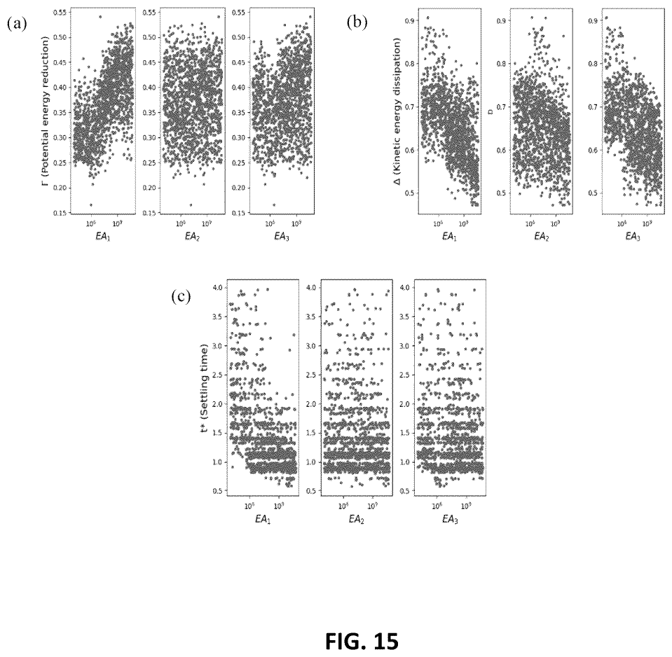

FIG. 15 depicts the variation in three performance measures in terms of the variations in the three axial stiffnesses for all 2,000 realizations (simulation runs). The aim of the optimization of the dynamics of the cable was to (i) maximize the potential energy reduction measure Γ, (ii) minimize the kinetic energy measure Δ, and (iii) minimize the settling time t*. By doing so, we sought the optimal combination of the three B-NES types that mitigates the vibrations of the cable in the least possible time.

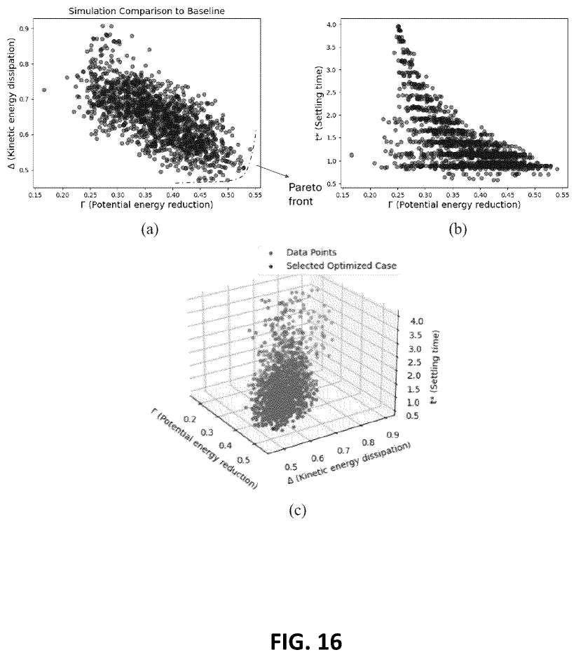

FIG. 16 is a multi-dimensional representation of the performance metrics for the simulation runs. FIG. 16 may be used to systematically identify an optimal configuration, manifesting as a Pareto front, through a multi-dimensional representation of performance metrics across various parameter planes, This Pareto front features the most optimal parameter sets, tailored to specific operational requirements. In the scenario examined, we extract the parameters of the B-NESs as shown in the first two columns of FIG. 14, corresponding to optimized performance with respect to the metrics (with optimal values), Δ=0.5064, Γ=0.5201, and t*=0.896. By employing the proposed optimization framework, we evaluate the efficacy of the B-NES devices across various simulation environments, facilitating the generation of a comprehensive 3D parameter space representation, as shown in graph (c) of FIG. 16. This spatial visualization aids in the strategic selection of the B-NES configurations by integrating all performance metrics into a single plot. Subsequently, we refine our selection process to isolate the optimal solution, ensuring it aligns with the complex dynamics of subsea cable systems. This approach not only enhances our understanding of the B-NESs' operational effectiveness but also provides a robust framework for deploying these devices in real-world scenarios, optimizing their performance to meet the stringent demands of dynamic subsea environments.

The optimal configuration of the B-NESs (FIG. 14) was rigorously tested to highlight and understand the dynamic interactions that govern the optimal vibration suppression of the tested subsea power cable.

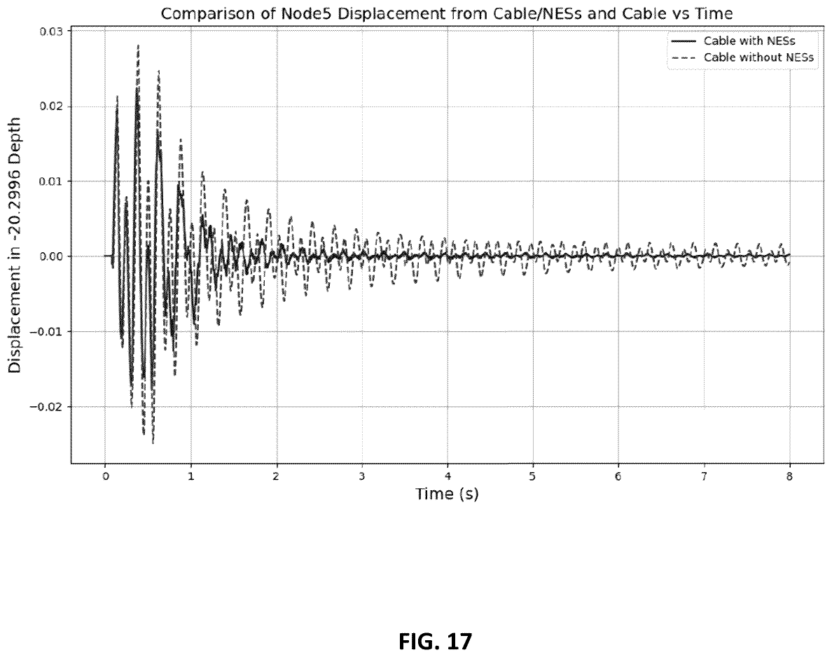

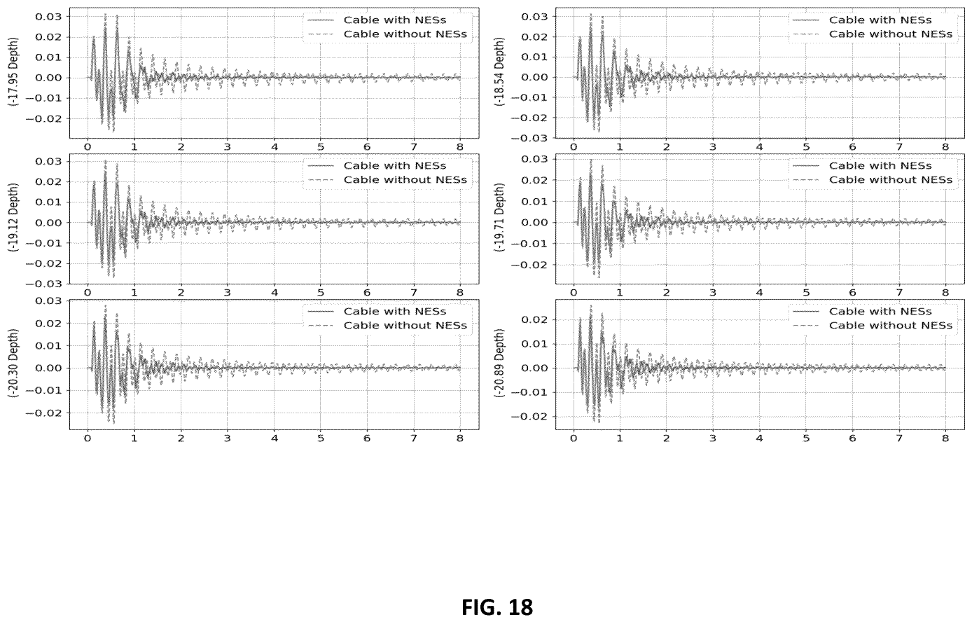

FIGS. 17 and 18 depict the significant reduction in the cable vibrations enabled by the B-NESs given the excitation profile (equation 22). FIG. 17 illustrates transient displacement at node 5 of the subsea cable for cases with and without optimizes B-NESs attached. FIG. 18 illustrates transient displacements at different locations along the subsea cable with optimized attached B-NES and with no B-NES attached. For comparison, we show also the corresponding responses of the “unprotected” cable, which incorporate the masses of the four B-NESs so that no mass-added effects distort the results. There is global mitigation of vibrations in the cable. The nonlinear beneficial effects of the B-NESs are not restricted to their points of attachment but extend to the entire cable.

The beneficial vibration suppression of the subsea cable vibrations by the B-NESs relies on two effects: (i) nonlinear targeted energy transfer (absorption) of broadband energy from the cable to the B-NES, where this energy is localized and dissipated, and (ii) rapid nonlinear “scattering” of vibration energy of the cable to higher frequencies within the cable itself. Indeed, such low-to-high energy transfer within the subsea cable yields an immediate attenuation of the cable vibrations (because the oscillation amplitudes decrease with increasing frequency); moreover, higher-frequency vibrations can be more effectively dissipated by the inherent dissipative capacity of the cable itself, compared to lower-frequency ones. We note that the bi-stability feature of the NESs significantly enhances vibration energy scattering from low to high frequencies within the subsea cable.

We now demonstrate the nonlinear energy scattering in the cable dynamics in the frequency domain, that is induced by the B-NESs. This is achieved by postprocessing the transient responses of FIG. 17 using numerical wavelet transform (WT) analysis. The WT is a powerful tool for time-frequency analysis and is particularly advantageous when dealing with transient, non-stationary signals such as those in our study. Unlike the conventional Fourier transform, which assumes that the signal is stationary and provides an averaged frequency representation, the WT is applicable to non-stationary signals (such as the nonlinear transient responses considered herein). As such, the WT enables localized frequency analysis, offering temporal resolution that captures the evolution of the main frequency components of the signal over time. This adaptability is crucial for dynamic analysis that seeks to track the transient evolutions of the frequency components of a measured signal. To apply a numerical continuous WT, we selected the Morlet wavelet, a complex wavelet family w (t) known for effectively separating the phase and amplitude of harmonic components within a signal. This wavelet family is defined using equation 23:

$$ψ ( t ) = {π}^{- \frac{1}{4}} ( {e}^{i {ω}_{c} t} - {e}^{\frac{ω \frac{2}{c}}{2}} ) {e}^{- \frac{{t}^{2}}{2}} \qquad Eq . 23$$

where ω_{c} represents the central frequency of the wavelet, allowing us to focus on specific frequency bands with the signal. Then, given a signal x(t), its continuous WT is expressed using equation 24:

$$X ( ω , t ) = \frac{ω}{\sqrt{π} {ω}_{c}} {\int }_{- ∞}^{∞} x ( s ) ( {e}^{i {ω}_{c} t} - {e}^{\frac{ω \frac{2}{c}}{2}} ) {e}^{- \frac{{( s - t )}^{2}}{{a}^{2}}} ds \qquad Eq . 24$$

where X(ω, t) is the complex WT of x(t). Given that this is a two-dimensional complex function of frequency and time, we typically study contour plots of its magnitude, |X(ω, t)|.

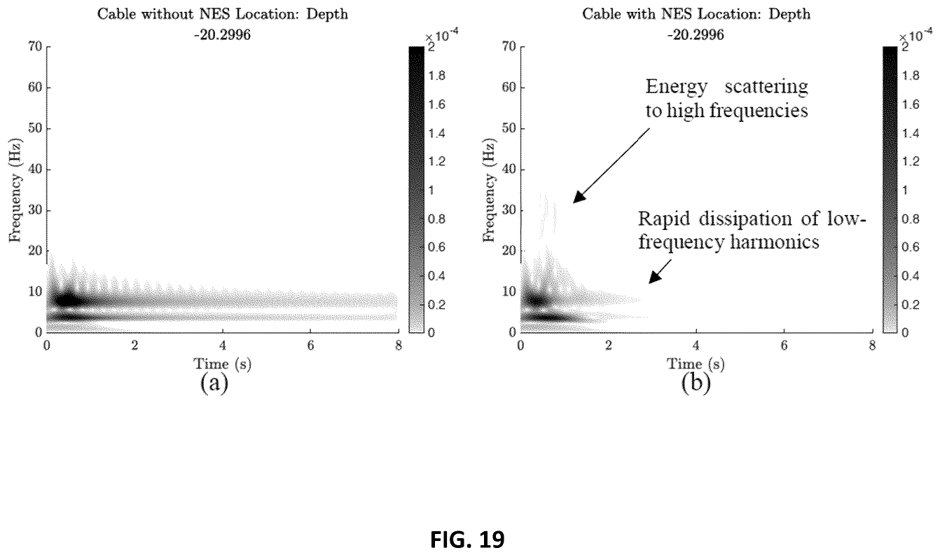

FIG. 19 illustrates contour plots of the wavelet transformation of cable responses in FIG. 17 for the case (a) without and (b) with B-NESs. FIG. 19 depicts the contour plots of the modulus, |X(ω, t)| of the WT of the transient nonlinear responses of FIG. 17.

These results reveal the mitigation effect of the B-NESs on the cable vibrations and explain the governing nonlinear dynamics that cause it. We note the much shorter duration of both dominant lower-frequency harmonics of the cable dynamics (introduced by the multi-frequency excitation) when the optimized B-NESs are attached (as shown in graph (b) of FIG. 19) compared to the unprotected cable (as shown in graph (a) of FIG. 19). FIG. 19 illustrates the efficacy of the B-NESs to mitigate multi-harmonic vibrations of the cable.

As discussed previously, this vibration mitigation effect is caused (i) by targeted energy transfer (unidirectional absorption) of multi-frequency vibration energy from the cable to the B-NESs, where the transferred energy is locally confined and rapidly dissipated, and (ii) by nonlinear scattering of the vibration energy of the cable from low to high frequencies (graph (b) of FIG. 19). This effect is followed by a marked suppression of all lower harmonics of the cable dynamics and underscores the B-NESs' capacity to passively adapt their resonances to multi-frequency excitations and, by doing so, to achieve broadband vibration suppression of the cable. Clearly, no such effects can be achieved by any linear design, e.g., the classical TMD, due to the narrowband operation of such devices and their inability to address multi-harmonic transient vibrations of the cable at broad frequency ranges.

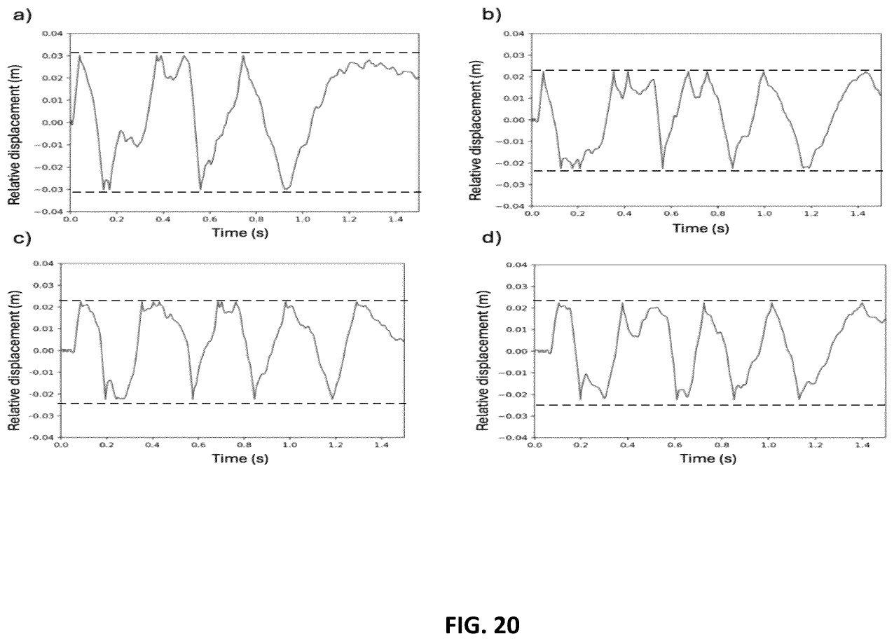

FIG. 20 illustrates relative displacement of optimized B-NES with respect to their point of attachment to the cable: (a) fairlead; (b,c) intermediate-antinode, (d) anchoring. Dashed lines indicate the points of “jumps” signifying bi-stability, i.e., sudden cross-well transitions of the dynamics between the different stable equilibria. To gain deeper insight into the nonlinear vibration mitigation of the cable due to the action of the optimized B-NESs, we examined the relative transient response of each B-NES with respect to the motion of the cable at its corresponding point of attachment (see FIG. 20). As a further step, we employed a WT to postprocess the relative responses of FIG. 20, providing insight into the transient evolution of the dominant harmonics of the relative response of the B-NES. In this way, we can study how each B-NES absorbs broadband energy from the cable through resonance capture and how each B-NES operates as a “nonlinear scatterer” of vibration energy from low to high frequencies. As discussed previously, this latter feature promotes a highly effective mechanism for rapid vibration mitigation.

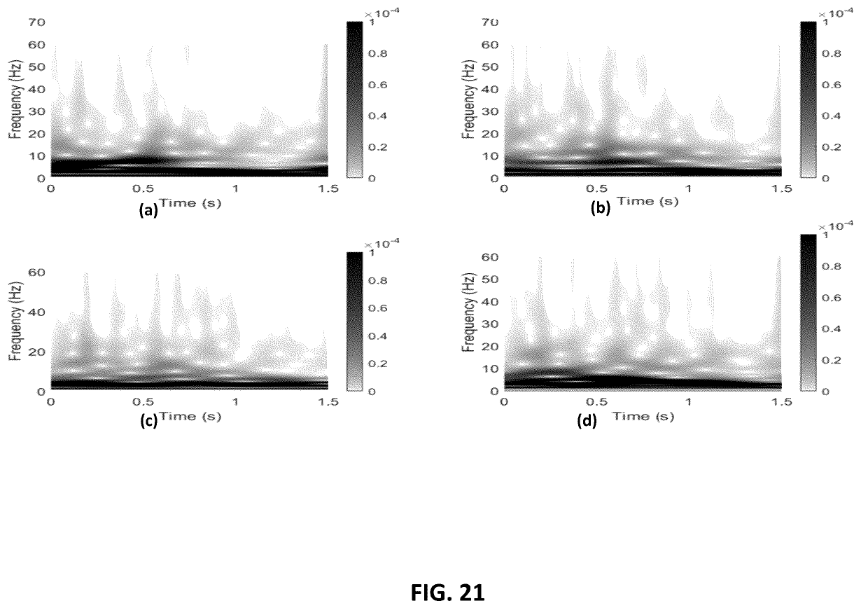

FIG. 21 illustrates contour plots of the magnitudes of the WT of the relative displacements of the optimized B-NESs of FIG. 19. As anticipated, the B-NESs exhibit cross-well oscillations, a phenomenon rooted in the bi-stability characteristics intrinsic to their design. This bi-stable behavior enhances the BNESs' ability to effectively scatter the vibrational energy of the cable. A detailed study of the relative displacements between each optimized B-NES mass and its cable attachment point provides deeper insight into the B-NESs' operational dynamics. Indeed, each optimized BNES demonstrates rapid response times and operates in a broadband fashion, i.e., both at lower and higher frequencies, showcasing their inherent passive tunability.

Passive tunability with respect to energy (and initial angle of inclination-see FIG. 9) is a hallmark of the B-NES's nonlinearity, and this strongly nonlinear device is intentionally designed with a complete absence of a preferential resonance frequency; rather, its instantaneous resonance frequency solely depends on its instantaneous energy, so it can passively adapt (tune) its resonance to excitations of varying intensity. The resulting tunability of the B-NES resonance frequency makes it exceptionally suited for handling broadband and highly non-stationary excitations (cable vibrations) of the type that are typically encountered in VIV scenarios. This capability underscores the B-NES's robust mitigation efficacy and its capacity to dynamically adapt to and mitigate complex vibrational patterns across changing operational conditions.

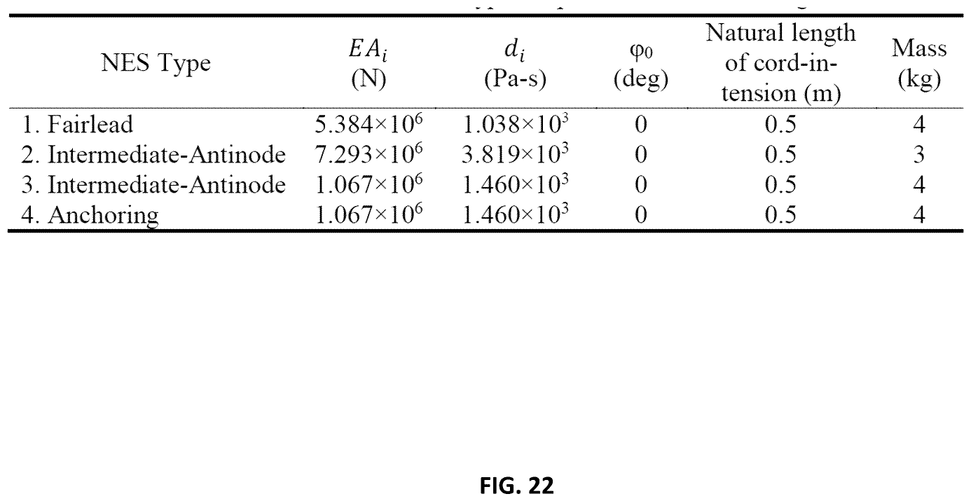

The effect of bi-stability on the cable mitigation is further highlighted when comparing the performance of the previous B-NESs with “plain” NESs without bi-stability features. These NESs are obtained by setting the initial angle of inclination (i.e., angle at equilibrium) to Ø₀=0⁰ (see FIG. 10) and reducing the axial stiffnesses of the cords-in-tension. Then we obtain a purely cubic nonlinear stiffness characteristic for each NES as shown in graph (a) of FIG. 12 and complete elimination of the bi-stability phenomenon. This is an extra manifestation of the tunability of the NESs with respect to geometry. This can be implemented in MoorDyn simply by adjusting the ratio of the natural lengths of the cords relative to the rod length to a value of 1. FIG. 22 provides the specific parameters for the set of four NESs.

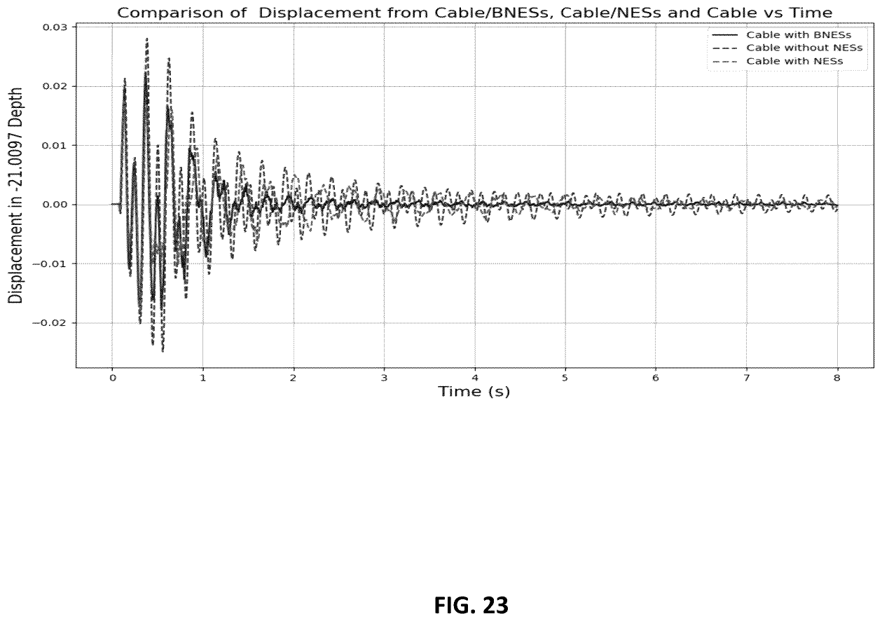

FIG. 23 illustrates transient displacement at node 5 of the subsea cable for subsea cables with B-NESs, with NESs, and without NESs.

Under the same multi-harmonic excitation conditions described previously, FIG. 23 presents a comparison of the mitigating performance of the B-NESs and the plan NESs, which clearly demonstrates that while the cable equipped with plain NESs exhibits reduced oscillation amplitudes, the optimized B-NESs are more effective in mitigating the cable vibrations. This enhanced performance is attributed to the bi-stability effect, which provides the extra capacity of the B-NESs to rapidly scatter vibration energy from low-to-high frequencies, and by doing so, more efficiently dissipating the vibration energy.

In synopsis, an aspect of the B-NES's functionality is its capacity to tune its resonance frequency as the energy and frequency content of the transient vibration varies. Unlike linear systems that are constrained by fixed resonance frequencies, the B-NES showcases a unique adaptability where its response (resonance) frequency diminishes concomitantly with energy levels. This characteristic not only enhances the passive tunability of the B-NES across a broader frequency spectrum but also drastically improves its mitigation effectiveness in diverse operational scenarios by dynamically adjusting to the energy and frequency profile of the induced vibrations. This energy-dependent frequency adjustment exemplifies the B-NES's superior adaptability compared to traditional linear vibration mitigation devices, providing a tailored response to the specific energy conditions encountered in subsea environments. On top of that, the extra bi-stability feature enables rapid unidirectional (targeted) energy transfer from low-to-high frequencies, which, in turn, quickly reduces the vibration amplitude and dissipates the vibration energy more effectively.

The robustness of the B-NES in mitigating vibrations of dynamic subsea cables may be investigated by incorporating stochastic excitations that model real-world uncertainties. We also account for variations in the cables' dynamic properties due to environmental factors such as biofouling, demonstrating the B-NES's ability to adapt and maintain effective vibration control under changing operational conditions.

To demonstrate the robustness of the B-NES under the varying environmental conditions in which the subsea power cable operates, we incorporate stochasticity into the excitation force by employing a custom excitation function. This function includes random variations in amplitude, frequency, and phase, thereby emulating realistic stochastic conditions. Specifically, the excitation at each time step i of the active time duration of the excitation is defined using equation 25:

$$F ( i ) = {\sum }_{j = 1}^{3} {A}_{variation} [ j ] \cdot sin ( i \cdot {ω}_{variation} [ j ] ) + Noise ( i ) , \qquad Eq . 25$$

where Aᵥₐᵣᵢₐₜᵢₒₙ[j]~N(A, 0.1·A) introduces random variations in amplitude, ωᵥₐᵣᵢₐₜᵢₒₙ[j]~N(ω_{base}, 0.05·ω_{base}) introduces frequency shifts, φ[j]~Uniform (0, 2π) applies random phase offsets and Noise(i)~N(0,noiseₗₑᵥₑₗ) adds small scale Guassian noise to the excitation. By saving the excitation parameters, including Aᵥₐᵣᵢₒₐₜᵢₒₙ, ωᵥₐᵣᵢₒₐₜᵢₒₙ, Ø, and Noise we ensured reproducibility and enabled detailed analysis. This stochastic approach effectively represents real-world subsea environments, where external forces are inherently unpredictable due to varying environmental disturbances. Furthermore, it provides a robust testing framework for evaluating the broadband capability and adaptability of the B-NES under dynamic and uncertain loading conditions.

In addition to uncertainties introduced by external forces, biofouling can alter the fundamental frequency of subsea cables by affecting their effective stiffness and mass distribution. To demonstrate the robustness of the B-NES, we simulated the effect of biofouling by varying the cable's diameter (D) and mass-in-air density (MassInairDens) in the ranges D=[0.08, \0.1,\0.12] m and MassInairDens=[5.73, \6.5,\7.5] kg/m.

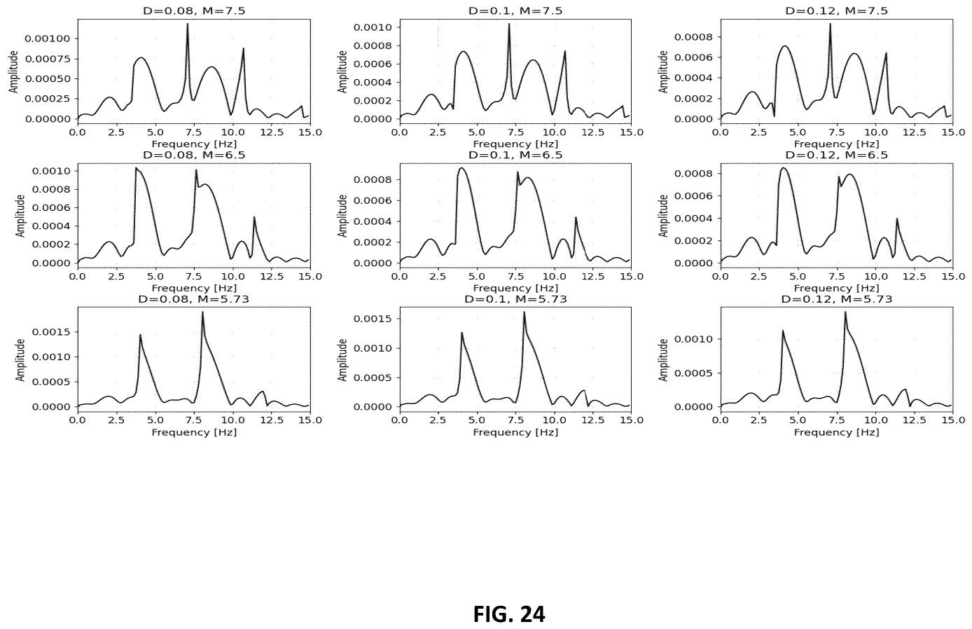

FIG. 24 illustrates Fast Fourier Transformation (FFT) plots of the transient displacement at node 5 of the subsea cable showing the variability of the frequency content of the dynamical response of the cable for different combinations of cable diameter (D) and cable mass density (M). Regarding the B-NES, leveraging the optimized solution described above, we applied the aforementioned stochastic excitation force-representing platform motion-to assess the robustness of the B-NES across all tested parameter variations. These FFT plots simulate the variability of the frequency content of the cable dynamics for biofouling and highlight the resulting shifts in resonance frequencies of the cable. This variability in the cable resonances necessitates the use of a broadband vibration mitigation device such as the BNES of our work, which, being a strongly nonlinear devices, passively tunes (i.e., self-adapts) its resonance response to maintain its mitigation effectiveness over broad frequency ranges. Clearly, this is not possible using the conventional linear tuned mass damper (TMD), which has a fixed resonance frequency and so has drastically deteriorating mitigation performance off resonance.

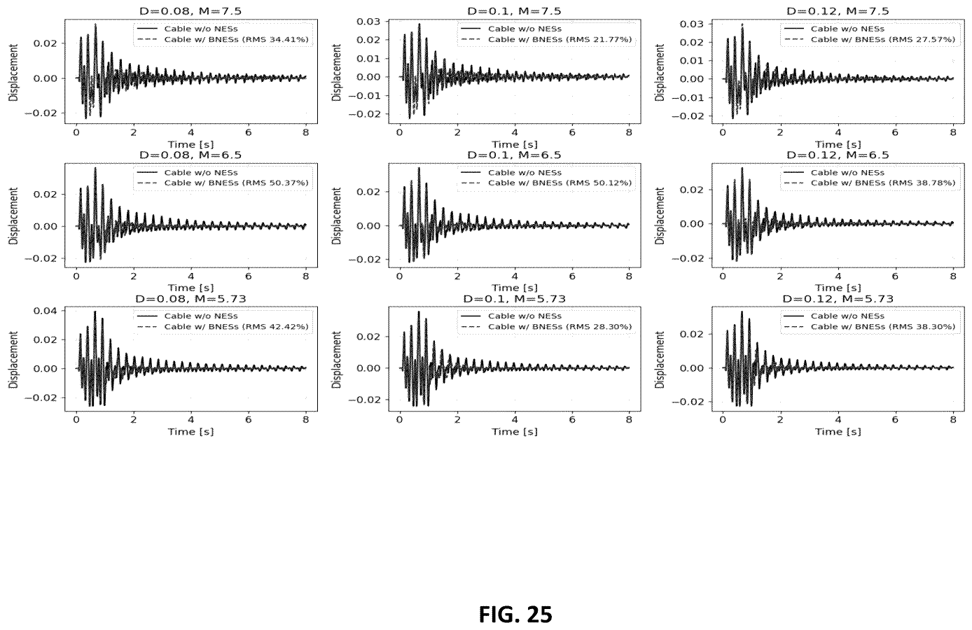

FIG. 25 illustrates Transient displacement (in m) at node 5 of the subsea cable for the cases with and without optimized B-NESs attached; different combinations of cable diameter (D) and mass density (M) are considered (corresponding to the FFT plots of FIG. 24) representing biofouling scenarios. Under nominal operating conditions (without biofouling), the B-NES achieved a 53.60% reduction in RMS displacement following the excitation, serving as a baseline for its performance. In the scenarios representing biofouling effects shown in FIG. 24, the B-NES maintained its effectiveness, achieving reductions in RMS displacement ranging from 21.77% to 50.37% (see FIG. 25). These results highlight the device's ability to adapt to dynamic changes in cable properties caused by biofouling, without requiring any parameter adjustments. The transient displacement time-series shown in FIG. 25 confirm the robust mitigation performance of the B-NES in suppressing the vibrations of the dynamic cables. Indeed, the nonlinear features of the B-NES enable it to maintain control over broadband vibration, ensuring robustness under altered cable dynamics. This self-adaptability renders the B-NES a suitable and practical solution for real-world subsea cable applications, where environmental conditions like biofouling introduce uncertain and continuously varying operating scenarios.

In this work, we investigated the stabilization of dynamic subsea power cables typically used in offshore wind farms by means of B-NESs. These are strongly nonlinear passive absorbers with a capacity for mitigating broadband vibrations. The B-NES configuration is relatively simple, as it relies on an oscillating mass that is connected to the subsea cable by means of inclined spring-damper pairs. It is interesting that although these devices are composed of linear stiffness and dissipation elements, their dynamics is strongly nonlinear due to geometric and kinematic nonlinearities; that is, the nonlinearities are generated by the relative oscillation of the mass of a B-NES with respect to the point of attachment to the cable. We used a lumped mass model to simulate the subsea cable's dynamics with or without B-NESs attached using the open-source MoorDyn library, which is widely adopted for simulating dynamic marine structures. This simulation framework allowed us to capture the complex interactions between the subsea cable and external environmental forces, such as tidal currents and platform motions. Multiple B-NESs were attached to the cable, and our formulation facilitated accurate replication of the B-NESs' nonlinear dynamical behaviors by directly mapping their physical characteristics to simulation parameters within the MoorDyn software.

To ensure the validity and robustness of our models, we performed a thorough analytical and numerical study. The analytical results provided a baseline for understanding the fundamental dynamics of the integrated cable/B-NES system, while numerical simulations confirmed the accuracy of our model's predictions. This dual validation approach strengthened the credibility of our findings, ensuring that the model effectively captured the intricate mechanical interactions involved in subsea dynamic power cable stabilization.

The study leveraged a HPC to conduct extensive parametric studies and optimizations, exploring a wide parameter space for the B-NES configurations. Specifically, we considered a vertical subsea baseline cable with four B-NESs attached at strategic locations, subject to prescribed multi-harmonic platform motion at very low frequencies typical of sea wave excitation. By running 2,000 discrete simulations on the University of Illinois Urbana-champaign HPC cluster, we were able to optimize the system parameters of the B-NESs to maximize vibration mitigation across a broad frequency range. Using HPC for this computationally intensive process enabled us to efficiently explore multiple B-NES design variations and identify optimal configurations that would not be feasible using traditional methods.

Our optimization framework demonstrated that the B-NESs can adapt to the nonstationary and broadband vibrational inputs that are typical in subsea environments, a capability that allowed them to outperform traditional (linear) TMDs. Indeed, unlike TMDs, which are limited by their narrowband resonance properties and require precise tuning, the B-NESs demonstrated their unique capacity to dynamically adjust their resonance to frequency shifts, providing effective, broad-spectrum energy absorption and mitigation without the risk of amplifying oscillations outside a narrow frequency range (in contrast to TMDs). What enables this ability is the strong (non-linearizable) stiffness nonlinearity of B-NESs, which yields a variable resonance frequency that passively adapts with the changing excitation. This means that, in contrast to the TMD, which has a predetermined resonance frequency, the B-NES is capable of resonating and absorbing energy of cable vibrations with continuously changing frequency and intensity. Moreover, “jumps” in the B-NES transient dynamics due to bistability (i.e., jumping back and forth between two stable equilibrium positions) contribute even more to the mitigation efficacy, as the B-NESs act as rapid “scatterers” of vibration energy from lower to higher frequencies within the cable itself. This scattering yields rapid attenuation and dissipation of cable vibrations in a robust way that simply is unattainable with current linear passive mitigating devices.

Our robustness analysis introduced stochastic excitations to capture real-world uncertainties and accounted for variations in the cable's dynamic properties induced by environmental factors such as biofouling. Despite these shifts in the cable's resonant frequencies, the B-NES consistently maintained significant vibration suppression. This outcome further validates the B-NES's broadband capabilities and underscores its potential as a reliable solution for real-world dynamic subsea power cable applications, where environmental and operational conditions are inherently variable.

In summary, this the computer modeling has established the B-NES as a promising passive vibration mitigating device, which, despite its relatively simple configuration, is capable of efficiently and robustly addressing the challenges of vibration mitigation in subsea cable dynamics. This technology, in turn, has the potential to significantly prolong the operational life of cables by reducing the vibration-induced stresses that lead to fatigue and wear. Hence, our findings indicate that B-NESs offer a feasible and impactful retrofit option for enhancing the resilience and stability of existing subsea power infrastructure in offshore wind farms.

While the present invention has been described with reference to specific examples, which are intended to be illustrative only and not be limiting of the invention, it will be apparent to those of ordinary skill in the art that changes, additions, and/or deletions may be made to the disclosed embodiments without departing from the spirit and scope of the invention.

The foregoing description is given for clarity of understanding only, and no unnecessary limitations should be understood therefrom, as modifications within the scope of the invention may be apparent to those having ordinary skill in the art.

What is claimed is:

1. A nonlinear energy sink for a subsea cable, the nonlinear energy sink comprising:
a pair of end masses:
at least one post-buckled bar extending between the pair of end masses; and
a compressive load assembly extending between the pair of end masses, the compressive load assembly configured to apply a compressive force to the at least one post-buckled bar.

2. The nonlinear energy sink of claim 1, wherein the compressive load assembly comprises:
a segmented shaft including a pair of threaded bolts, each of the pair of threaded bolts extending from a respective one of the pair of end masses, and a threaded coupling coupled to the pair of threaded bolts,
wherein rotation of the threaded coupling is configured to change a length of the segmented shaft and a magnitude of the compressive force induced in the at least one post-buckled bar.

3. The nonlinear energy sink of claim 2, wherein rotation of the threaded coupling in a first direction is configured to increase the length of the segmented shaft and reduce the magnitude of the compressive force induced in the at least one post-buckled bar.

4. The nonlinear energy sink of claim 3, wherein rotation of the threaded coupling in a second direction is configured to decrease the length of the segmented shaft and increase the magnitude of the compressive force induced in the at least one post-buckled bar.

5. The nonlinear energy sink of claim 1, wherein the at least one post-buckled bar comprises two or more post-buckled bars extending between the pair of end masses.

6. The nonlinear energy sink of claim 1, further comprising:
a clamp configured to couple the pair of end masses, the at least one post-buckled bar, and the compressive load assembly to the subsea cable.

7. The nonlinear energy sink of claim 6, wherein the clamp includes a pair of arcuate segments hingedly coupled to one another, the pair of arcuate segments configured to be closed around the subsea cable, interlocking with one another and securing the subsea cable within the clamp.

8. The nonlinear energy sink of claim 6, wherein the clamp is configured to couple the at least one post-buckled bar to the subsea cable, such that the at least one post-buckled bar is perpendicular to the subsea cable.

9. The nonlinear energy sink of claim 1, wherein the nonlinear energy sink has two or more stable equilibrium positions.

10. A vibration mitigation device for a subsea cable, the vibration mitigation device comprising:
a pair of end masses;
a bar extending between the pair of end masses; and
a compressive load assembly, the compressive load assembly configured to apply a compressive force to the bar, buckling the bar, such that the bar exhibits a non-linear stiffness.

11. The vibration mitigation device of claim 10, wherein the compressive load assembly comprises:
a segmented shaft including a pair of threaded bolts, each of the pair of threaded bolts extending from a respective one of the pair of end masses, and a threaded coupling coupled to the pair of threaded bolts,
wherein rotation of the threaded coupling is configured to change a length of the segmented shaft and a magnitude of the compressive force induced in the bar.

12. The vibration mitigation device of claim 10, further comprising:
a clamp configured to couple the pair of end masses, the bar, and the compressive load assembly to the subsea cable.

13. The vibration mitigation device of claim 12, wherein the clamp includes a brace configured to receive a portion of the subsea cable and a rod extending between the brace and the bar.

14. A subsea cable system comprising:
a subsea cable; and
at least one nonlinear energy sink coupled to the subsea cable, the at least one nonlinear energy sink comprising:
a pair of end masses;
a post-buckled bar extending between the pair of end masses;
a compressive load assembly configured to apply a compressive force to bar; and
a clamp coupling the at least one nonlinear energy sink to the subsea cable,
wherein the at least one nonlinear energy sink is configured to reduce an intensity of vortex induced vibration of the subsea cable.

15. The subsea cable system of claim 14, wherein the at least one nonlinear energy sink is coupled to a portion of the subsea cable configured to extend between a floating body and a sea floor.

16. The subsea cable system of claim 14, wherein the at least one nonlinear energy sink comprises two nonlinear energy sinks.

17. The subsea cable system of claim 16, wherein the two nonlinear energy sinks are coupled to the subsea cable in different orientations.

18. The subsea power cable system of claim 17, wherein the two nonlinear energy sinks are offset in a range of 60 to 120 degrees from one another.

19. The subsea cable system of claim 14, wherein the compressive load assembly comprises:
a segmented shaft including a pair of threaded bolts, each of the pair of threaded bolts extending from a respective one of the pair of end masses, and a threaded coupled coupling the pair of threaded bolts,
wherein rotation of the threaded coupling is configured to change a length of the segmented shaft and a magnitude of the compressive force induced in the post-buckled bar.

20. The subsea cable system of claim 14, wherein the post-buckled bar has an elongated rectangular cross sectional shape.
